(19) United States
(12) Patent Application Publication
(10) Pub. No.: US 2018/0253807 A1
(43) Pub. Date: Sep. 6, 2018

(54) SYSTEM AND METHOD FOR PROVIDING CUSTOMIZED SINGLE FAMILY, MULTI FAMILY AND SHELTERED STRUCTURE

(71) Applicant: James Casper, New York, NY (US)

(72) Inventor: James Casper, New York, NY (US)

(21) Appl. No.: 15/880,254

(22) Filed: Jan. 25, 2018

Related U.S. Application Data
(60) Provisional application No. 62/450,301, filed on Jan. 25, 2017.
(60) Provisional application No. 62/477,079, filed on Mar. 27, 2017.
(60) Provisional application No. 62/536,686, filed on Jul. 25, 2017.
(60) Provisional application No. 62/620,999, filed on Jan. 23, 2018.

(51) Int. Cl. G06Q 50/16; G06Q 40/02; G06Q 10/08; G06F 3/0484; G06F 3/0481

(52) U.S. Cl. CPC G06Q 50/16; G06Q 40/025; G06F 3/0481; G06F 3/04847; G06Q 10/083

(57) ABSTRACT

On-demand customized and configurable structures in a highly efficient manner is provided. The structures may be manufactured and packaged for shipment to a remote location and may be assembled using minimum labor and without special expertise. The structures manufactured may include a higher fire resistance, higher quality controls, be customized to meet local zoning ordinances, be more energy efficient and resource conscious, and be built in a faster period of time at a lower cost with varying levels of non-luxury and luxury standards.

### PRIORITY

This application claims priority to U.S. Provisional 62/450,301, filed Jan. 25, 2017, U.S. Provisional 62/477,079, filed Apr. 27, 2017, U.S. Provisional 62/536,686, filed Jul. 25, 2017, and U.S. Provisional 62/620,999, filed Jan. 23, 2018, which are hereby incorporated by reference as if submitted in their entireties.

### FIELD OF THE INVENTION

The present invention relates to the selection and providing of dwellings or physical multiple purpose shelters, and, more particularly, to a system and method for providing on-demand customized shelters such as housing, buildings, commercial spaces using pre-manufactured integrative components.

### BACKGROUND OF THE INVENTION

The number of builders is rivaled only by the number of subcontractors and suppliers used by those same builders to produce a dwelling/shelter. The current marketplace generally demands the hiring of a general contractor who then hire and oversees any number of subcontractors. This model holds true for individual land owners looking to build a custom home, for buyers selecting a home in a classic subdivision, or a developer looking to build any type of building for any purpose. In all cases, a large number of skilled and unskilled workers/tradesmen are deployed on site to assemble and build, in a piecemeal fashion, a structure to a specific plan. The sheer number of workers, the need to be present on a remote site, and the ordering and delivery of materials, for example, all contribute a majority of the costs associated with building a structure or dwelling. Similarly, conflicts of time, schedules and interests by and between tradesmen, suppliers, foreman, developers and property owners, to name just a few who might have a stake in the project, may contribute to delays and mistakes, for example, which may also lead to excessive costs.

Thus, there is a need for a system that allows for a less expensive and less time consuming way to construct a customized structure. More particularly, there is a need for a system and method to provide a user application for the ordering and construction of a fully customized structure at a reasonable cost per square foot.

### SUMMARY

The present invention provides a system and method for providing on-demand customized and configurable structures in a highly efficient interlocking mechanism manner whereas a non to less-skilled abled bodied person with limited to no prior training can assemble a structure within a fraction of the time. The structures may be manufactured and packaged for shipment to a remote location and may be assembled using minimum labor and without special expertise. The structures manufactured by the present invention may include a higher fire resistance, higher quality controls, be customized to meet local zoning ordinances, be more energy efficient and resource conscious, and be built in a faster period of time at a lower cost with varying levels of non-luxury and luxury standards.

It is to be understood that both the foregoing general description and the following detailed description are exemplary and explanatory, and are intended to provide further explanation of the invention as discussed hereinthroughout.

### BRIEF DESCRIPTION OF THE DRAWINGS

The accompanying drawings are included to provide a further understanding of the disclosed embodiments. In the drawings:

FIG. 1 is a block diagram of an exemplary computing system for use in accordance with herein described systems and methods;

FIG. 2 is a block diagram showing an exemplary networked computing environment for use in accordance with herein described systems and methods;

FIG. 3 is an illustration of aspects of the present invention;

FIG. 4 is an illustrated expanded prospective of an aspect of the present invention;

FIG. 5 is an illustration of an aspect of the present invention;

FIG. 6 is an illustration of certain step associated with an aspect of the present invention;

FIGS. 7-9 are plan illustrations of certain embodiments of the present invention;

FIGS. 10-28 illustrate various embodiments and benefits of the present invention;

FIGS. 29-67 illustrate various sections of the customized housing in accordance with one or more embodiments of the present invention;

FIG. 68 illustrates an exemplary floor plan in accordance with at least one embodiment of the disclosed invention;

FIG. 69 illustrates another exemplary floor plan in accordance with at least one embodiment of the disclosed invention; and

FIG. 70 illustrates another exemplary floor plan in accordance with at least one embodiment of the disclosed invention.

### DETAILED DESCRIPTION

A computer-implemented platform and methods of use are disclosed that will provide the user the ability to create and have delivered a customized dwelling. It is to be understood that the type of shelter to be created is not limited to dwellings but includes others types of shelters (offices, hospitality, medical, homes, apartments etc . . . ). Described embodiments are intended to be exemplary and not limiting. As such, it is contemplated that the herein described systems and methods can be adapted to provide many types of users with access and delivery of any type of structures, and can be extended to provide enhancements and/or additions to the exemplary services described. The invention is intended to include all such extensions as an ecosystem that draws on add-on applications as needed. Reference will now be made in detail to various exemplary and illustrative embodiments of the present invention.

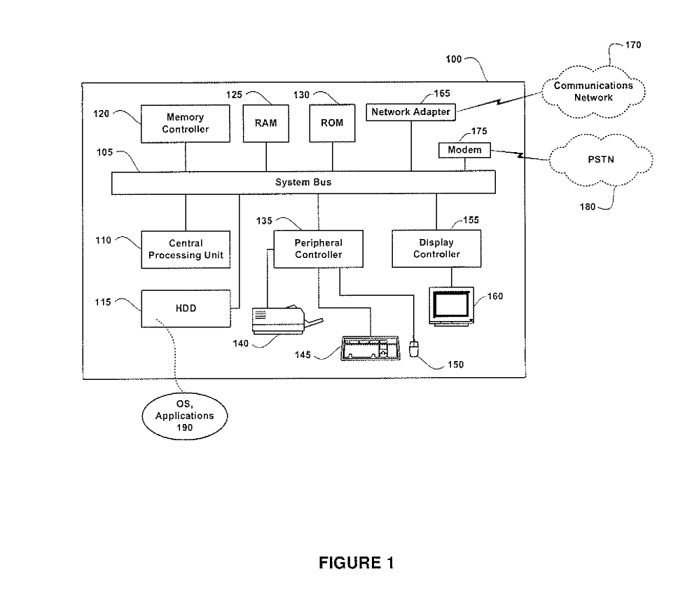

FIG. 1 depicts an exemplary computing system 100 that can be used in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the domain data discussed herein. Communications network 170 may provide user access to computing system 100 with means of communicating and transferring software and information electronically, and may be coupled directly to computing system 100, or indirectly to computing system 100, such as via PSTN or cellular network 180. For example, users may communicate with computing system 100 using communication means such as email, direct data connection, virtual private network (VPN), Skype® or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

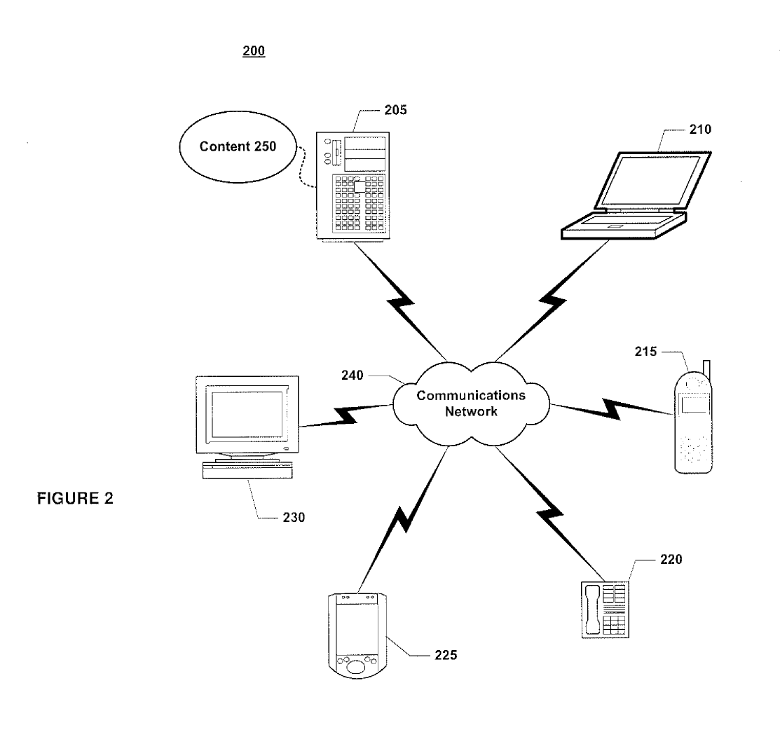

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or independently developed applications, the like, to interact with server 205.

The server 205 may thus deliver applications specifically designed for mobile client devices, such as, for example, client device 225. A client device 225 may be any mobile telephone, PDA, tablet or smart phone and may have any device compatible operating system. Such operating systems may include, for example, Symbian, RIM Blackberry OS, Android, Apple iOS, Windows Phone, Palm webOS, Maemo, MeeGo, Brew OS, and Linux for smartphones and tablets. Although many mobile operating systems may be programmed in C++, some may be programmed in Java and .NET, for example. Some operating systems may or may not allow for the use of a proxy server and some may or may not have on-device encryption. Of course, because many of the aforementioned operating systems are proprietary, in prior art embodiments server 205 delivered to client device 225 only those applications and that content applicable to the operating system and platform communication relevant to that client device 225 type.

JavaScript Serialized Object Notation (JSON), a lightweight, text-based, language-independent data-interchange format, is based on a subset of the JavaScript Programming Language, Standard ECMA-262, 3.sup.rd Edition, dated December 1999. JSON syntax is a text format defined with a collection of name/value pairs and an ordered list of values. JSON is very useful for sending structured data over wire (e.g., the Internet) that is lightweight and easy to parse. It is language and platform independent, but uses conventions that are familiar to C-family programming conventions. The JSON language is thus compatible with a great many operating systems (a list of such systems is available at www.json.org).

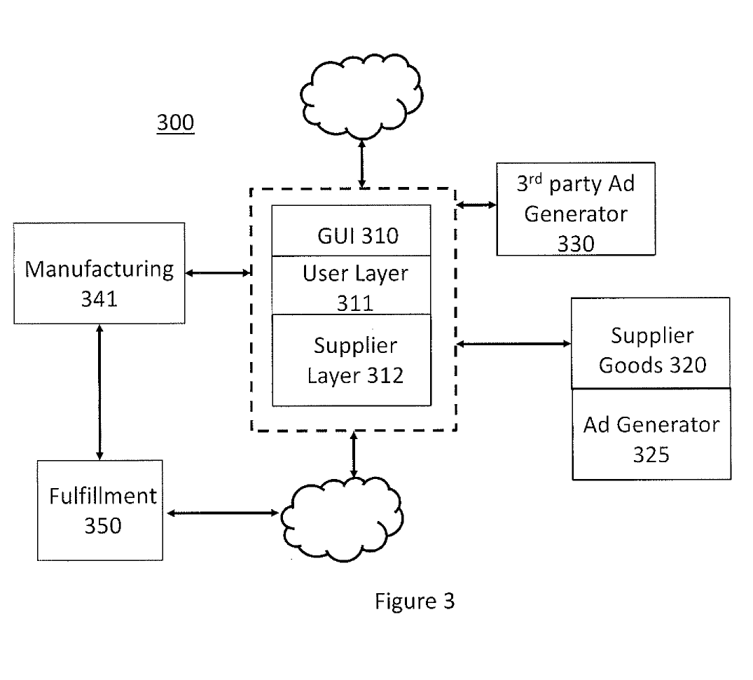

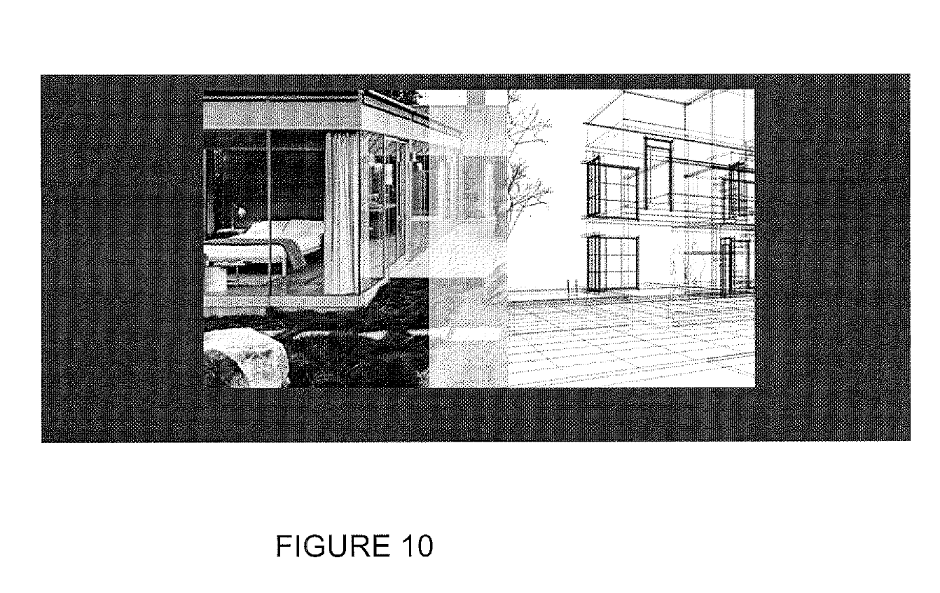

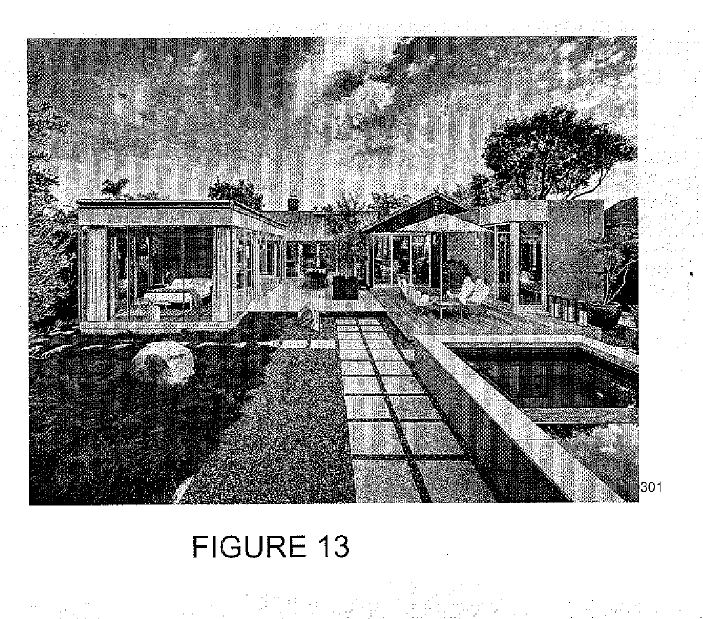

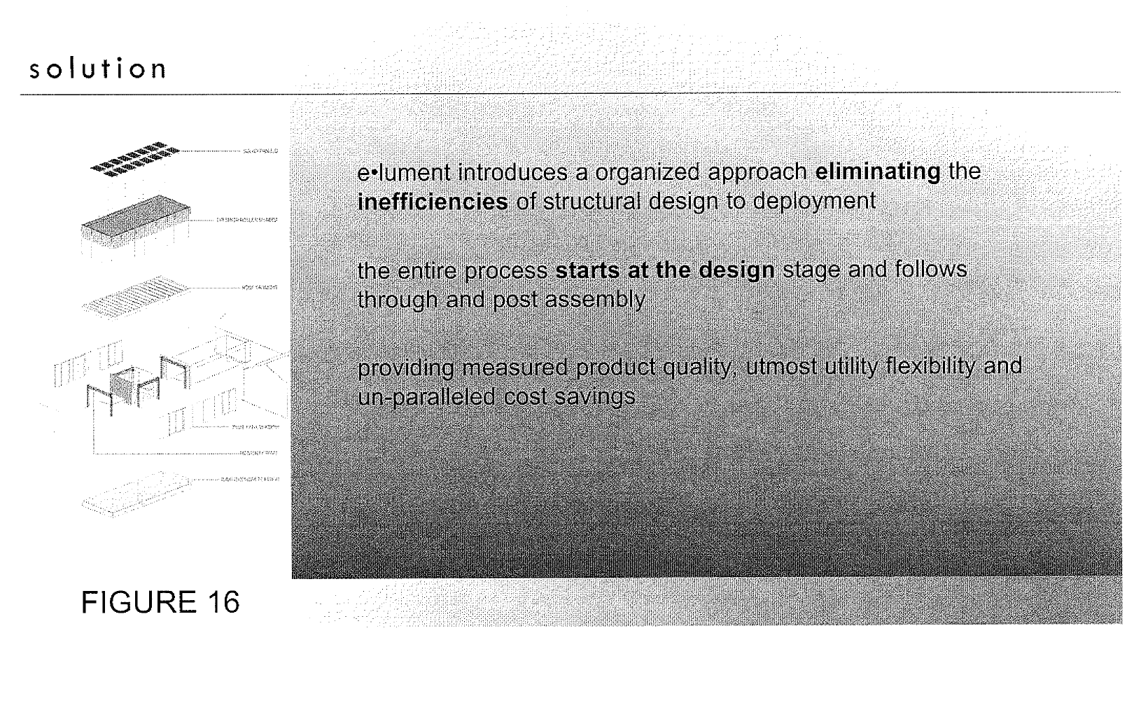

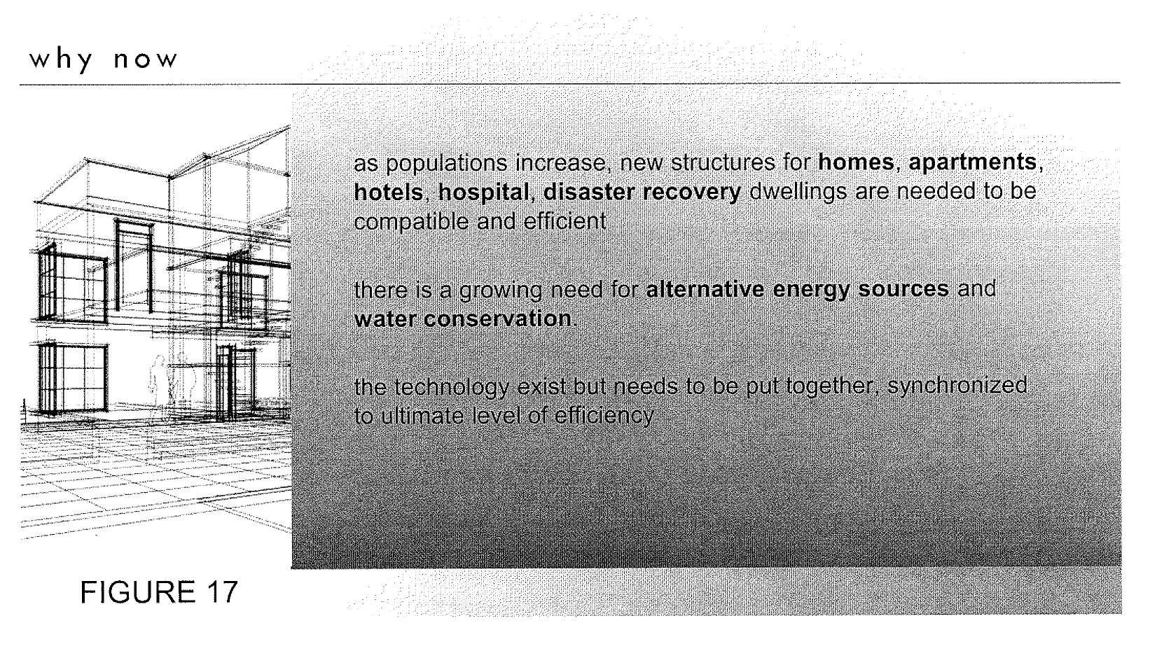

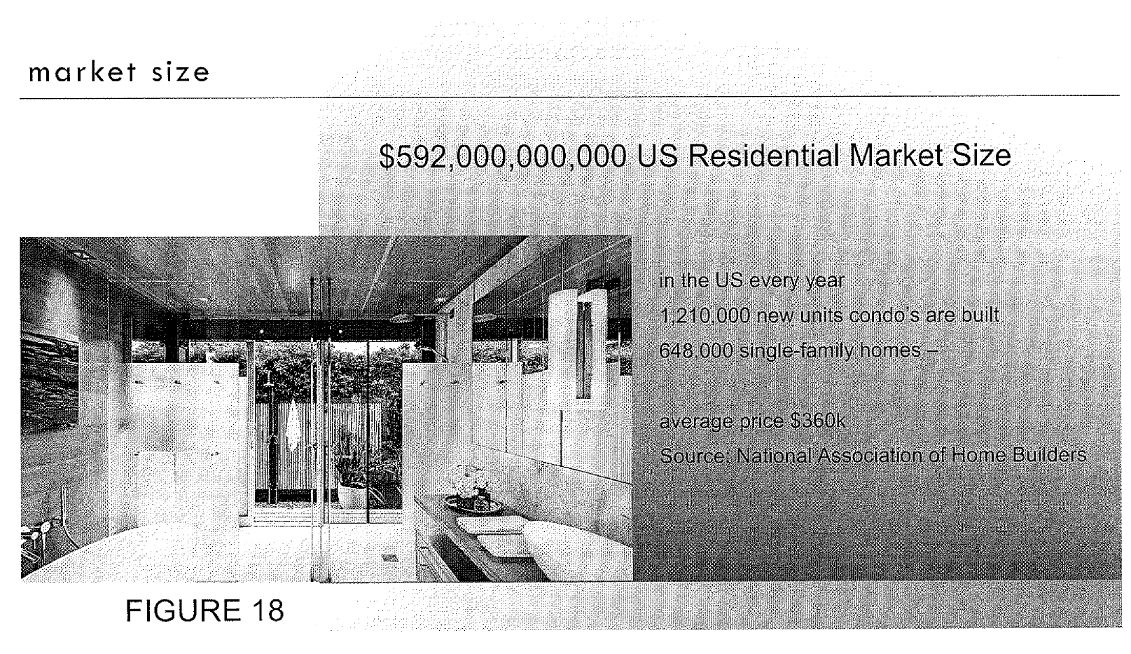

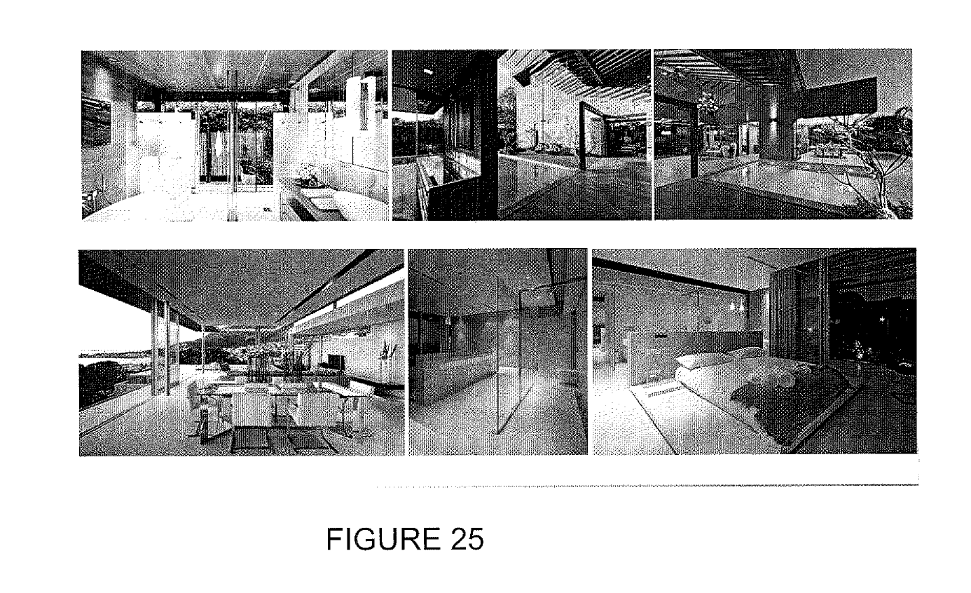

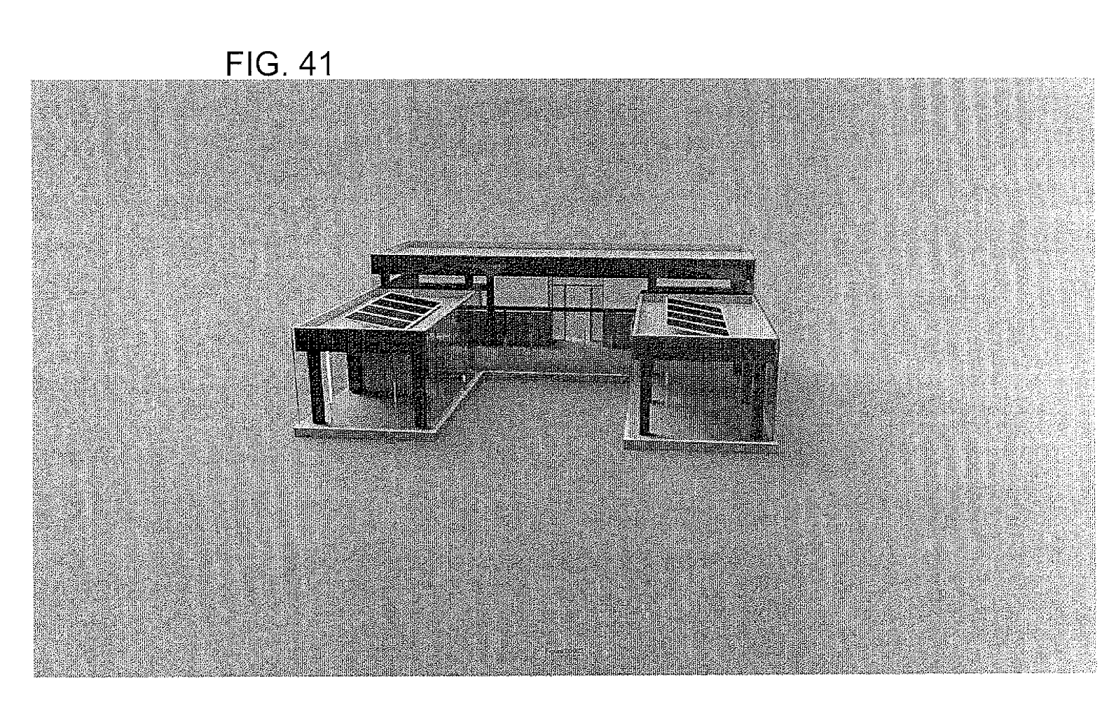

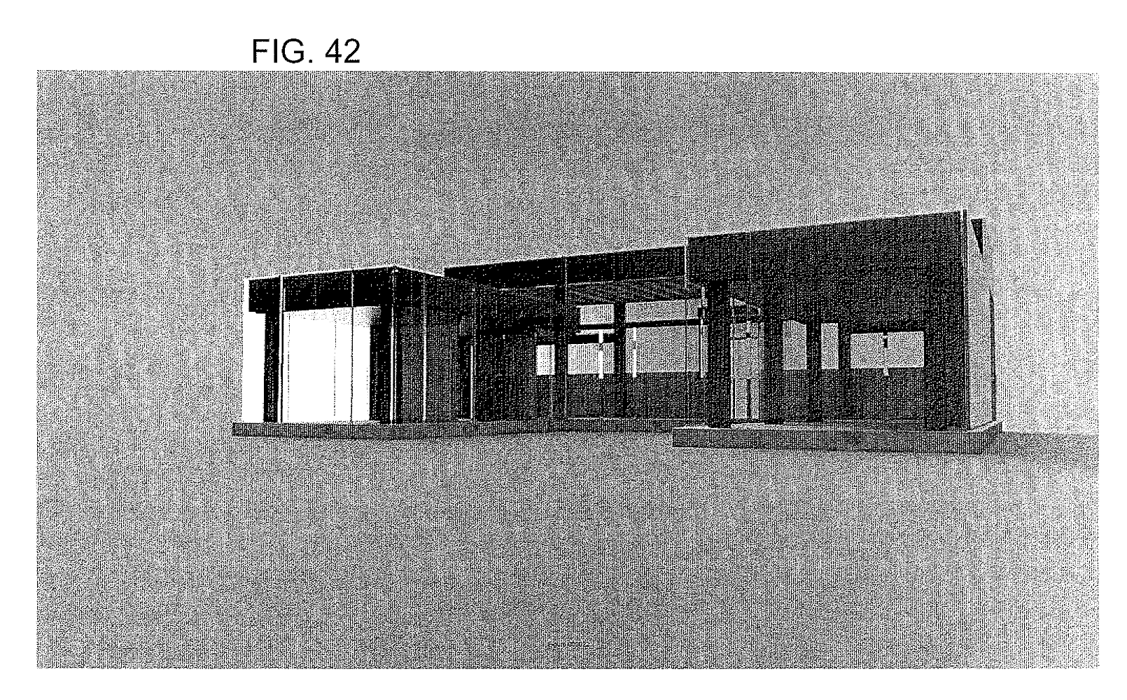

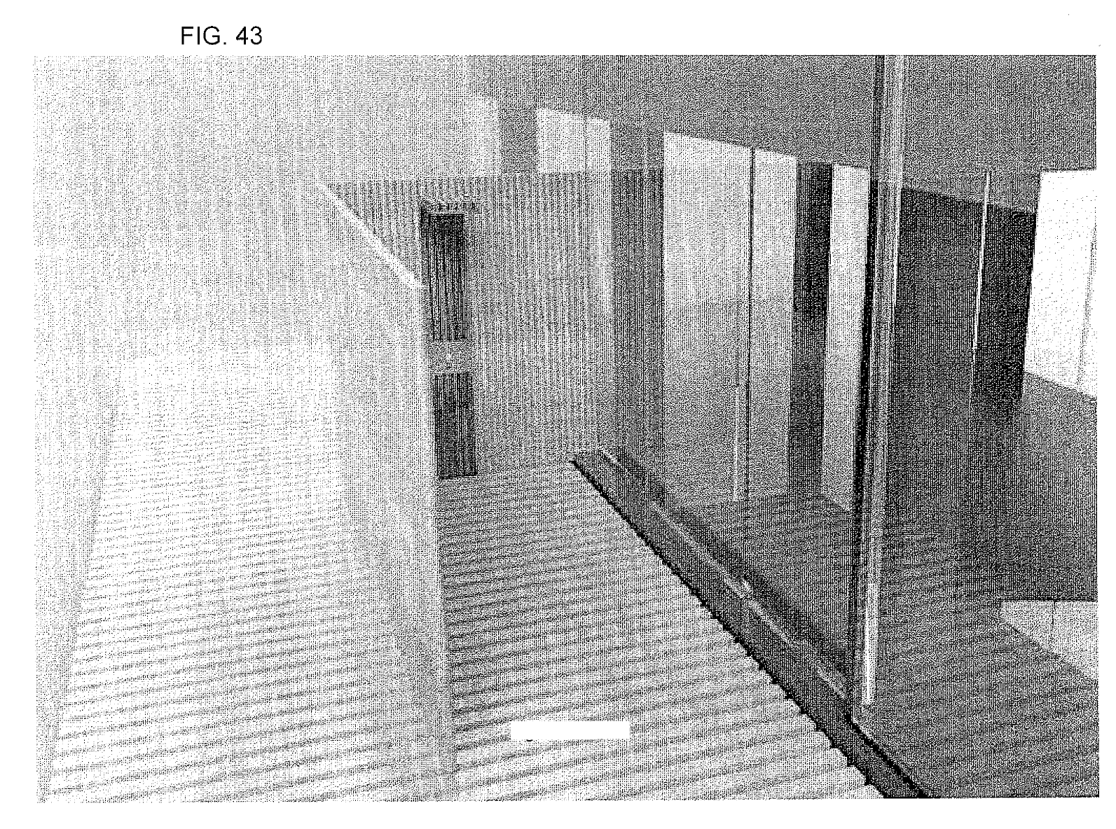

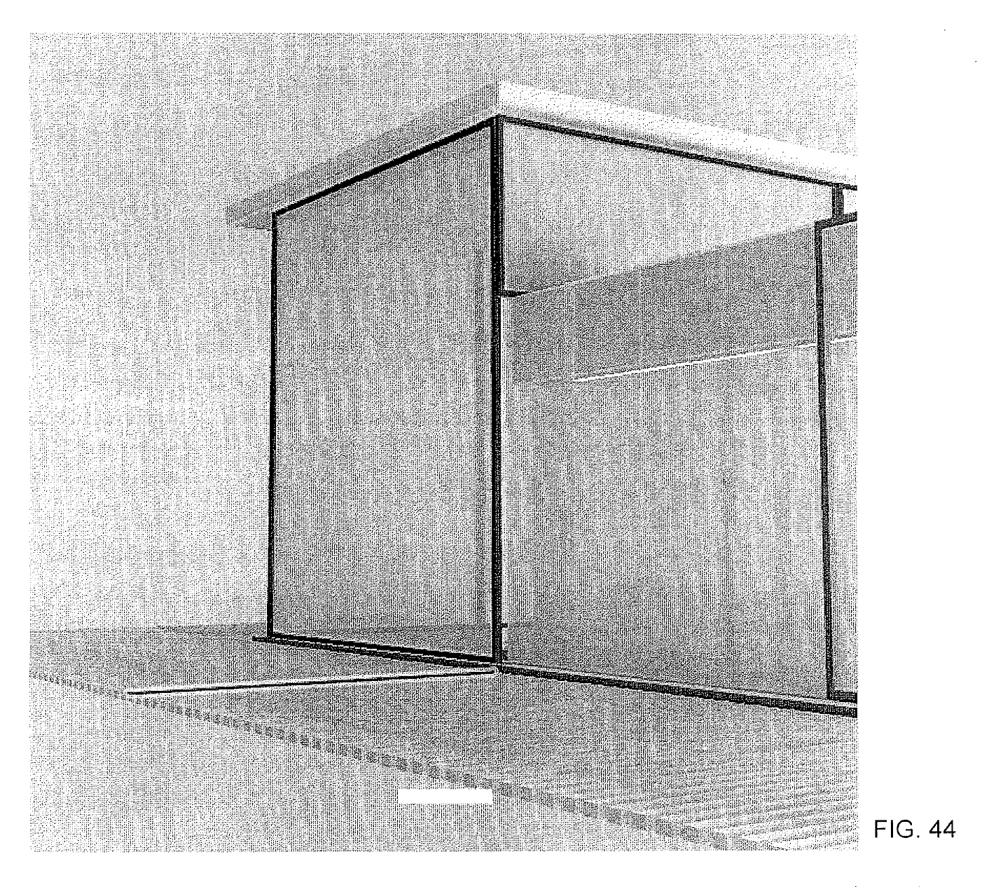

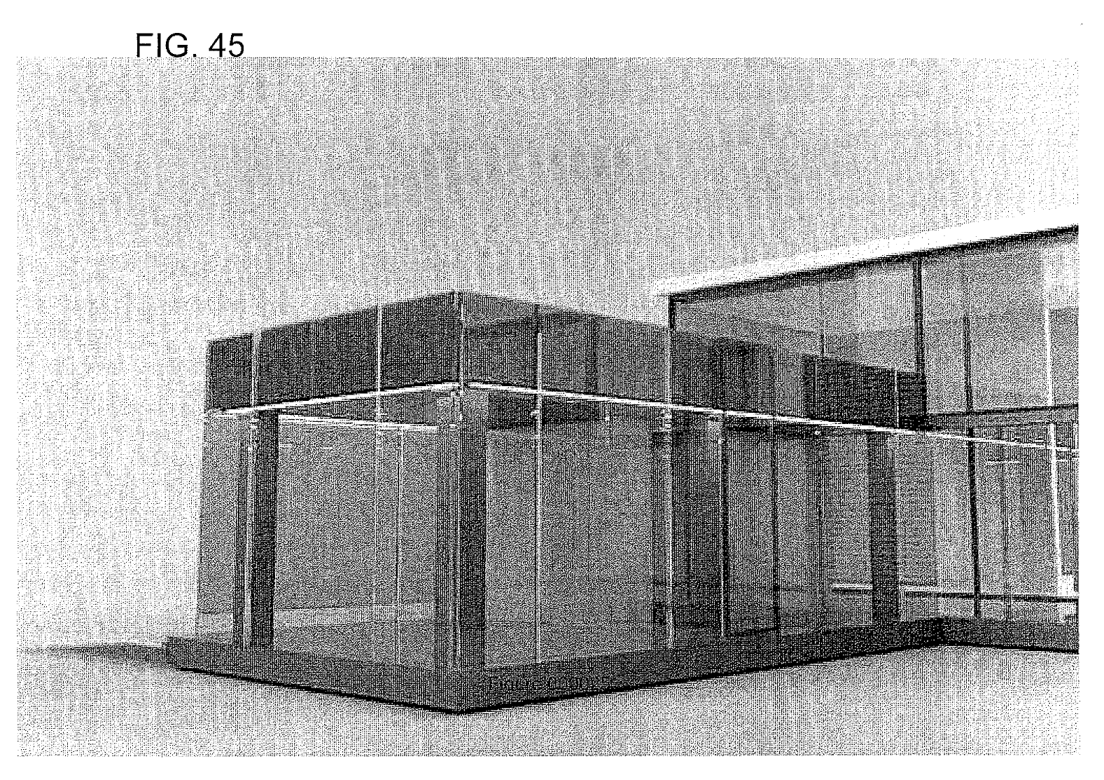

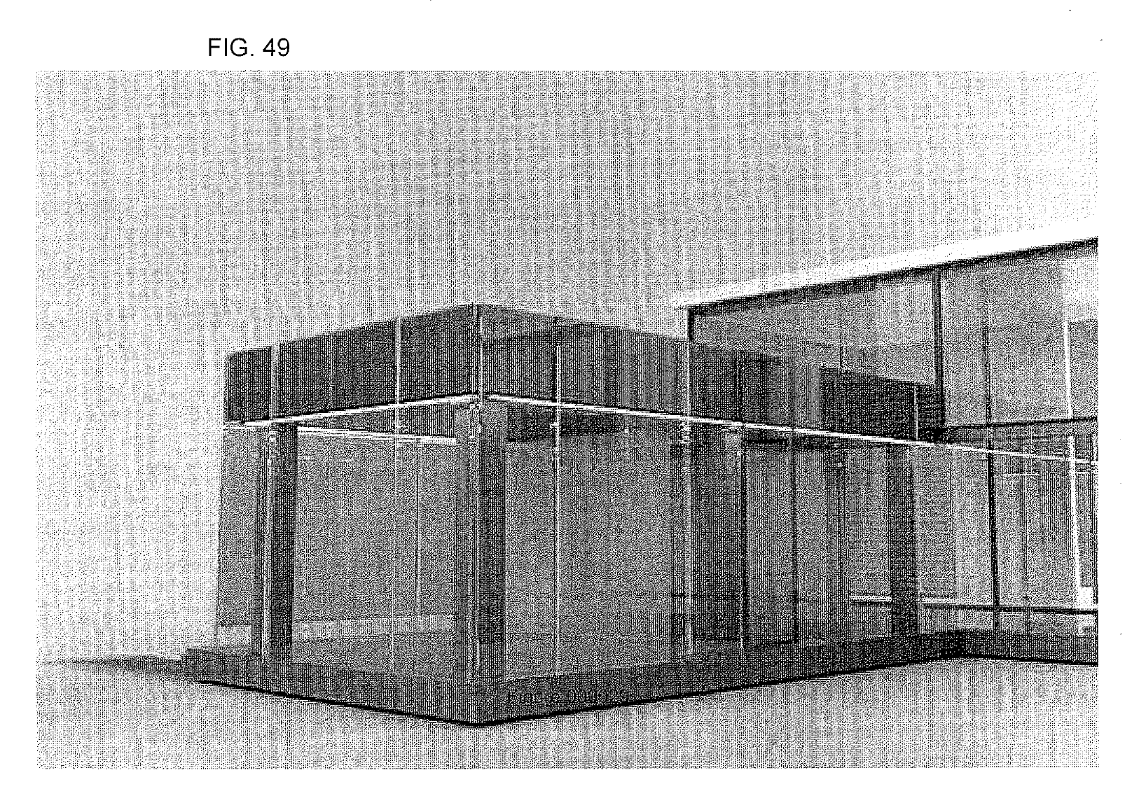

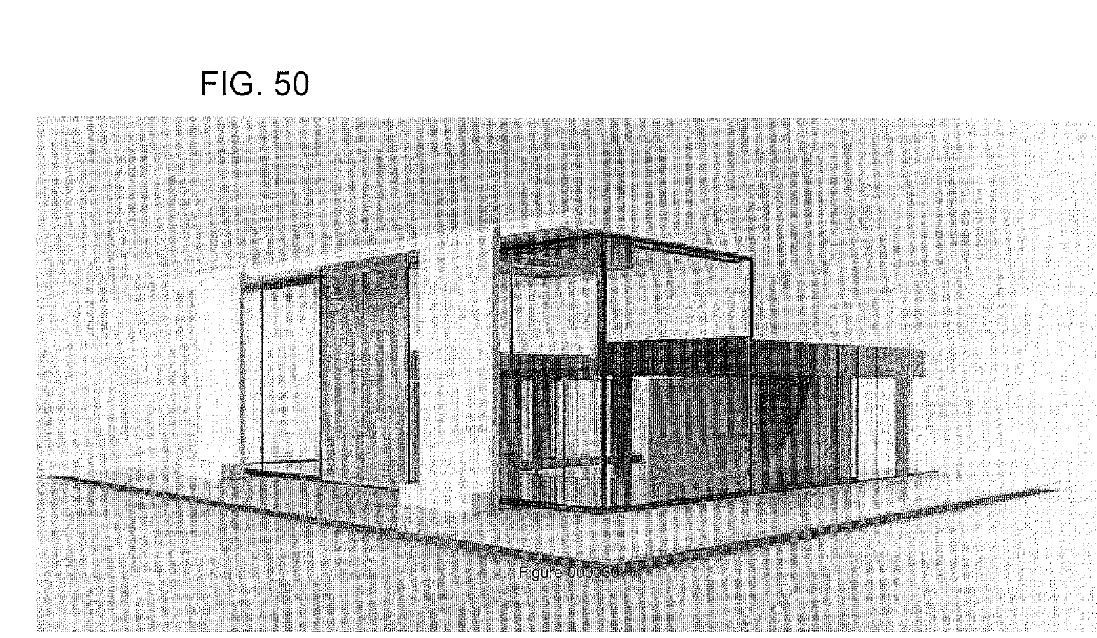

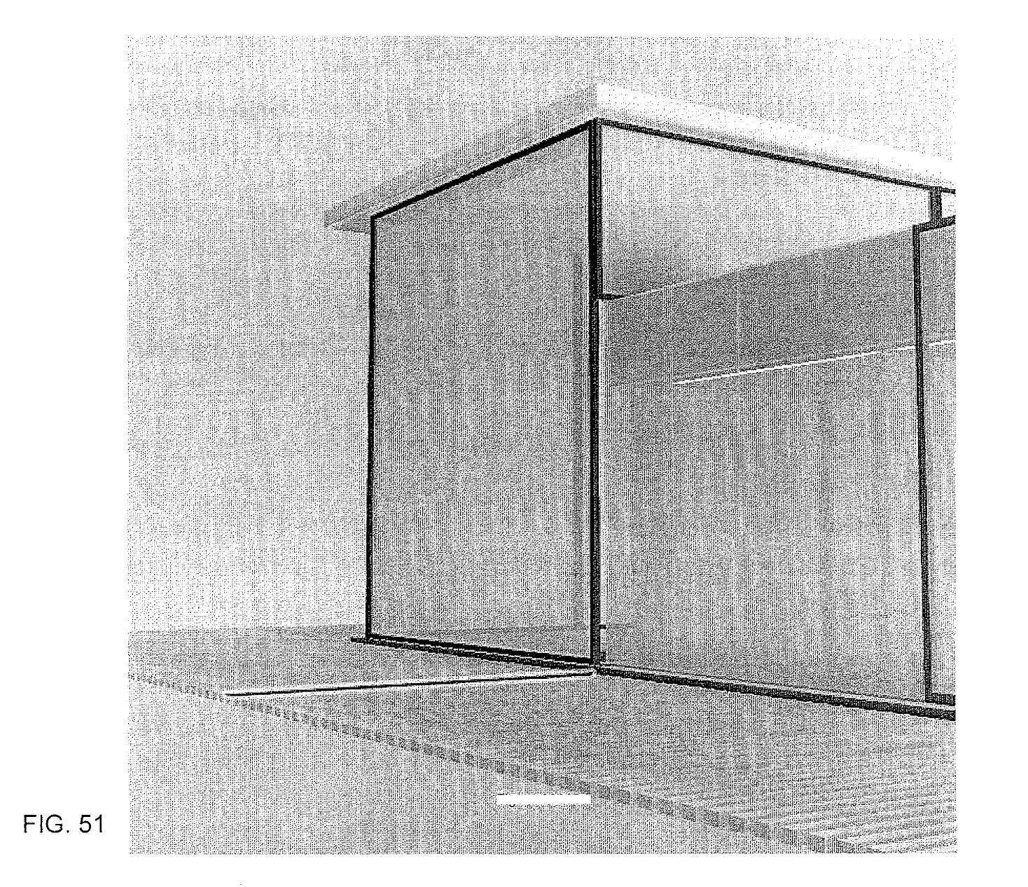

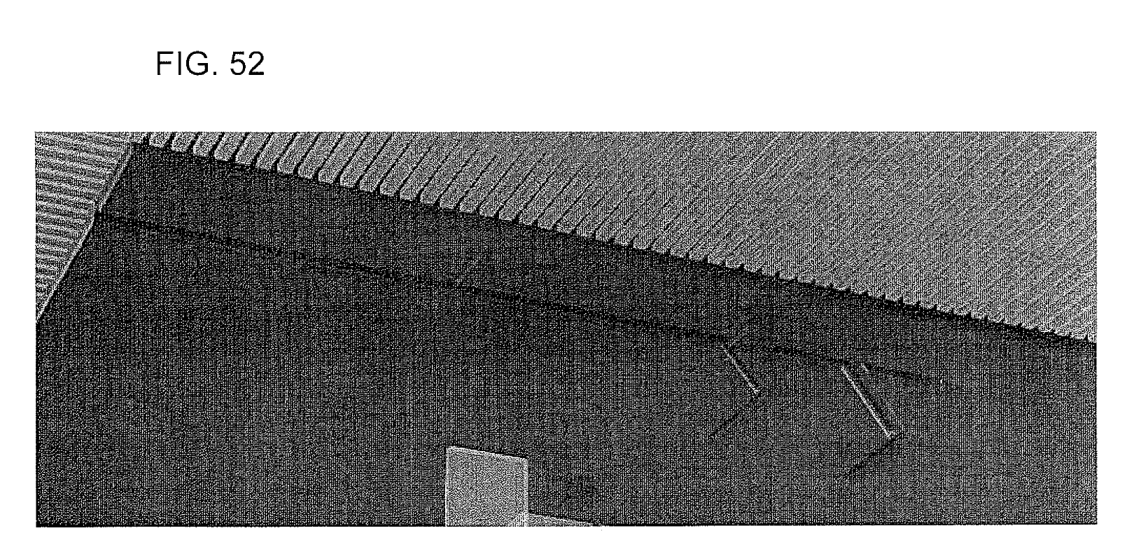

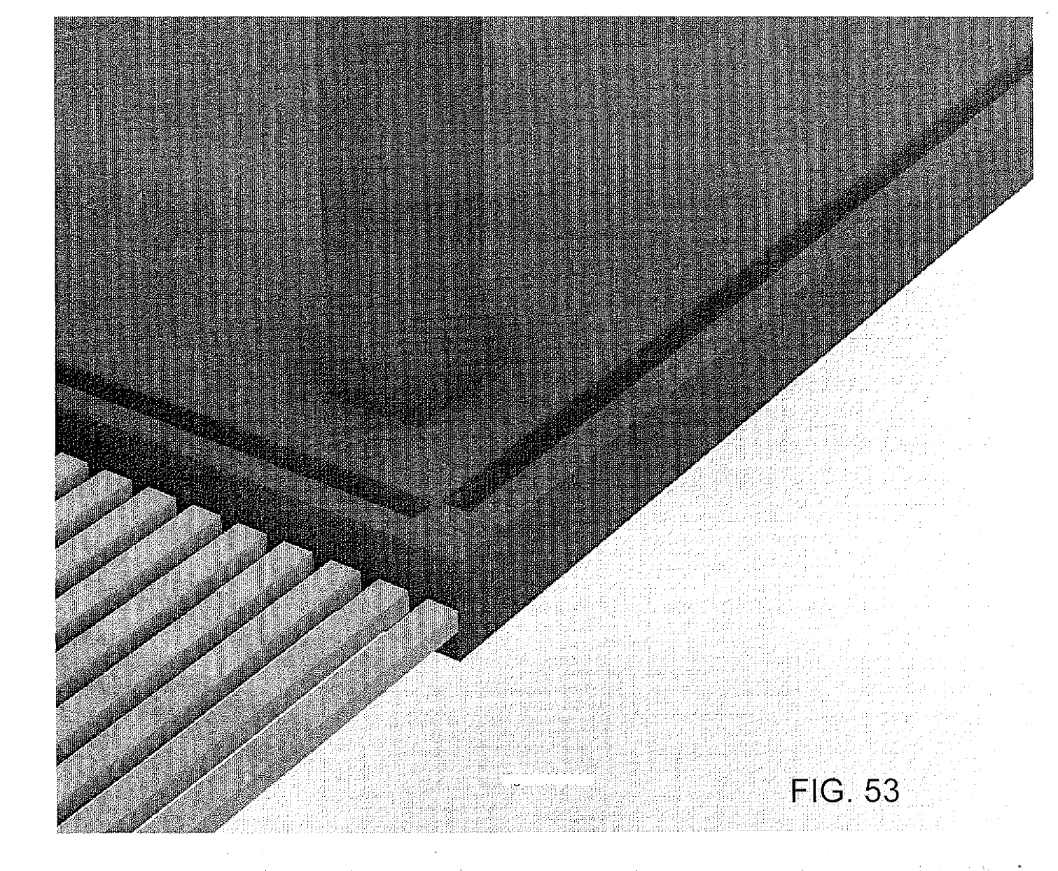

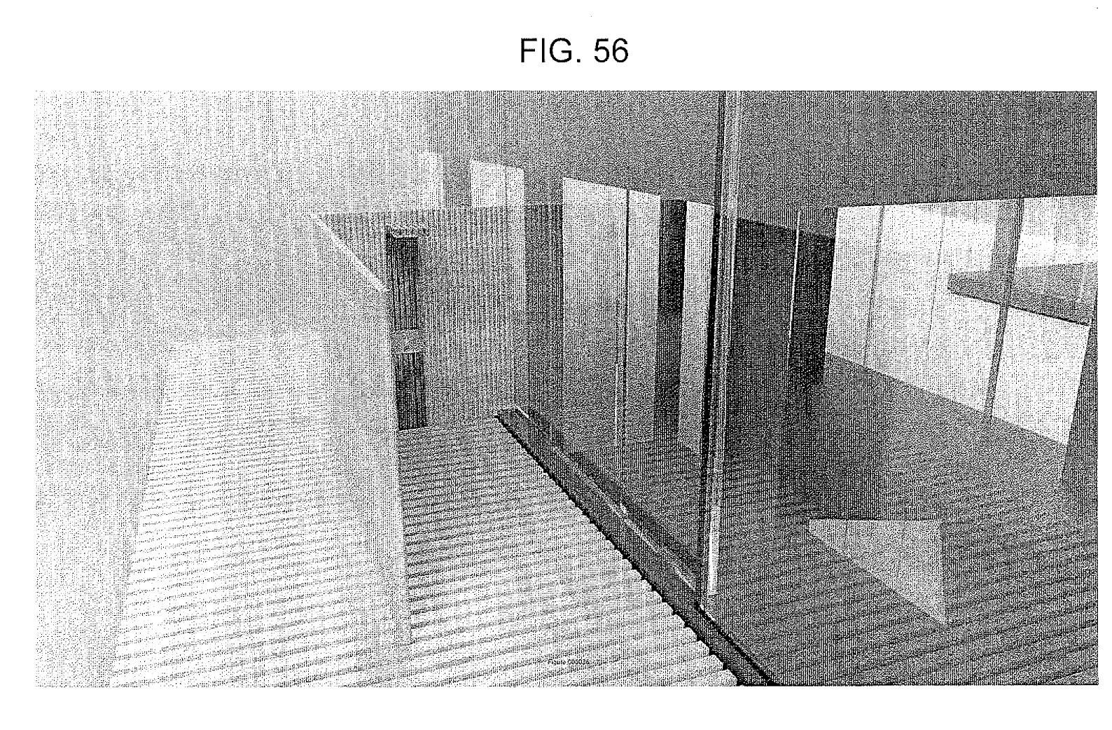

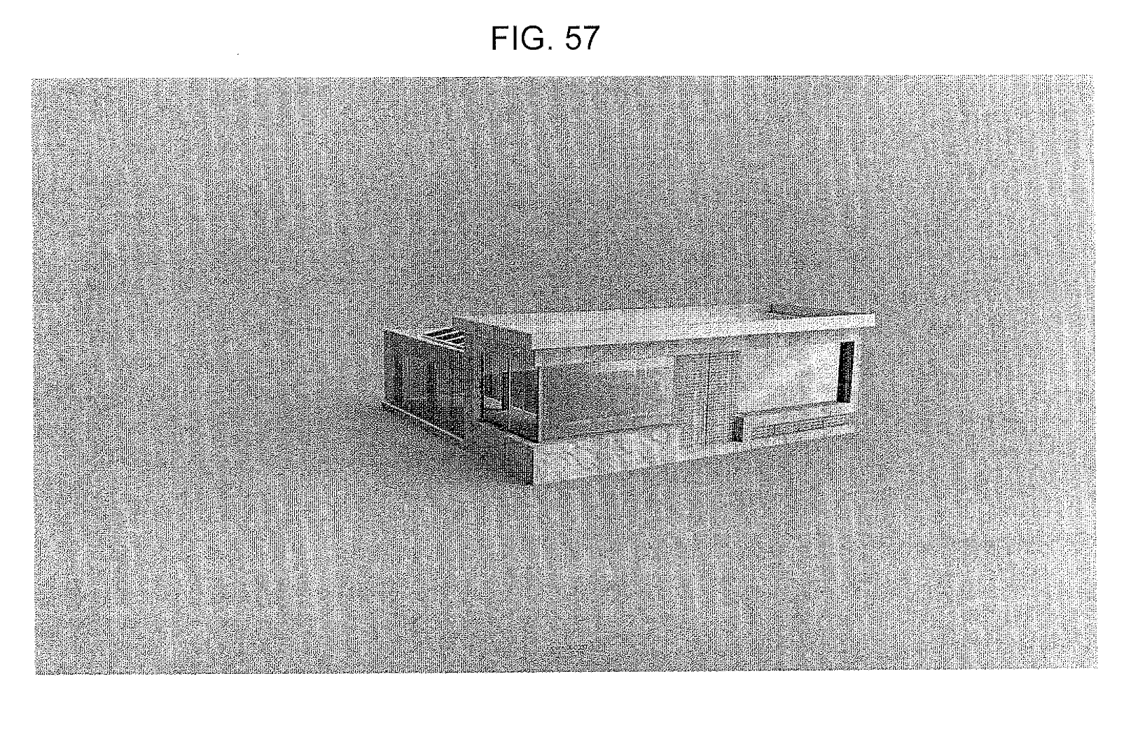

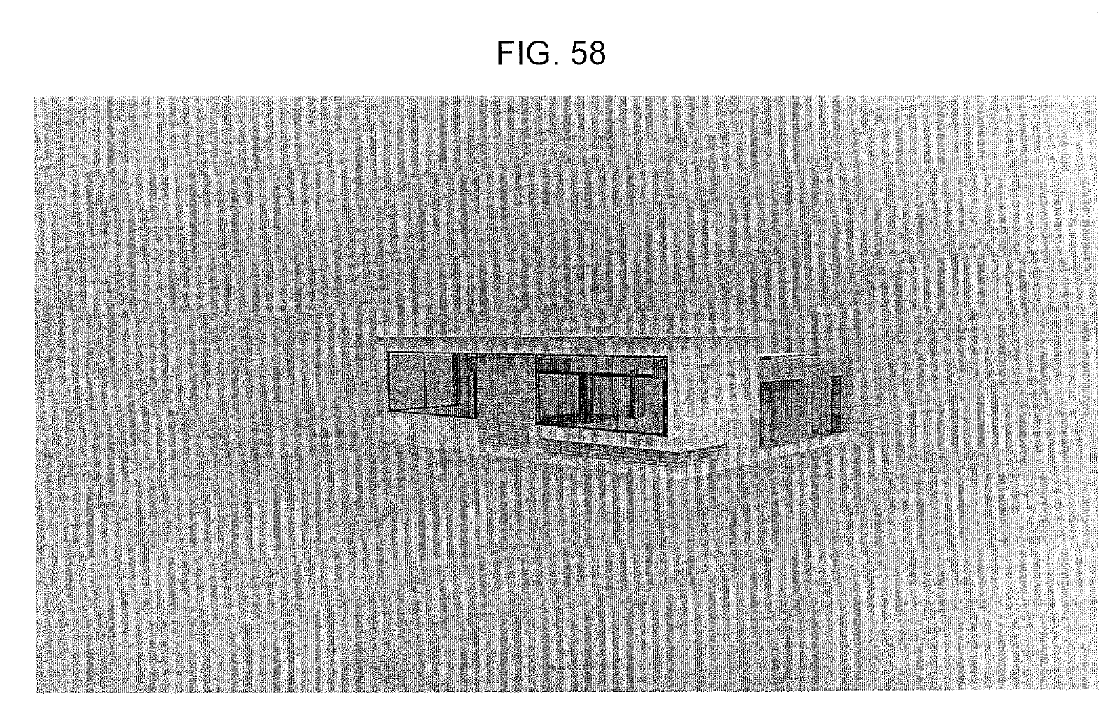

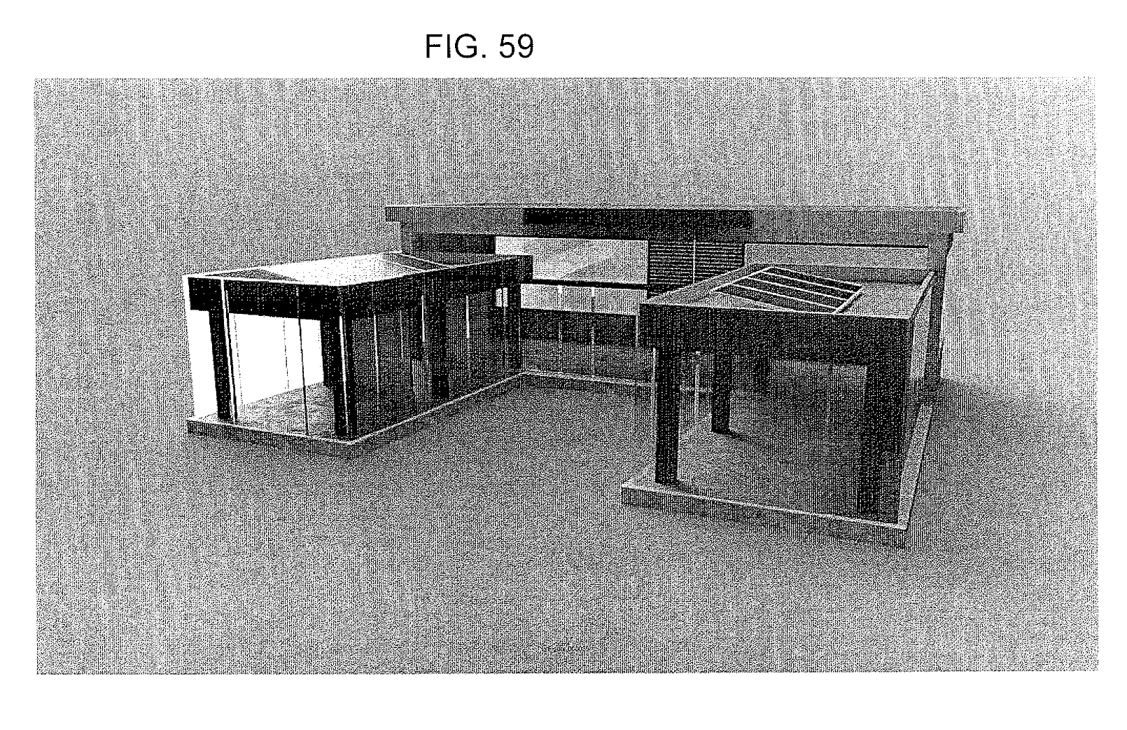

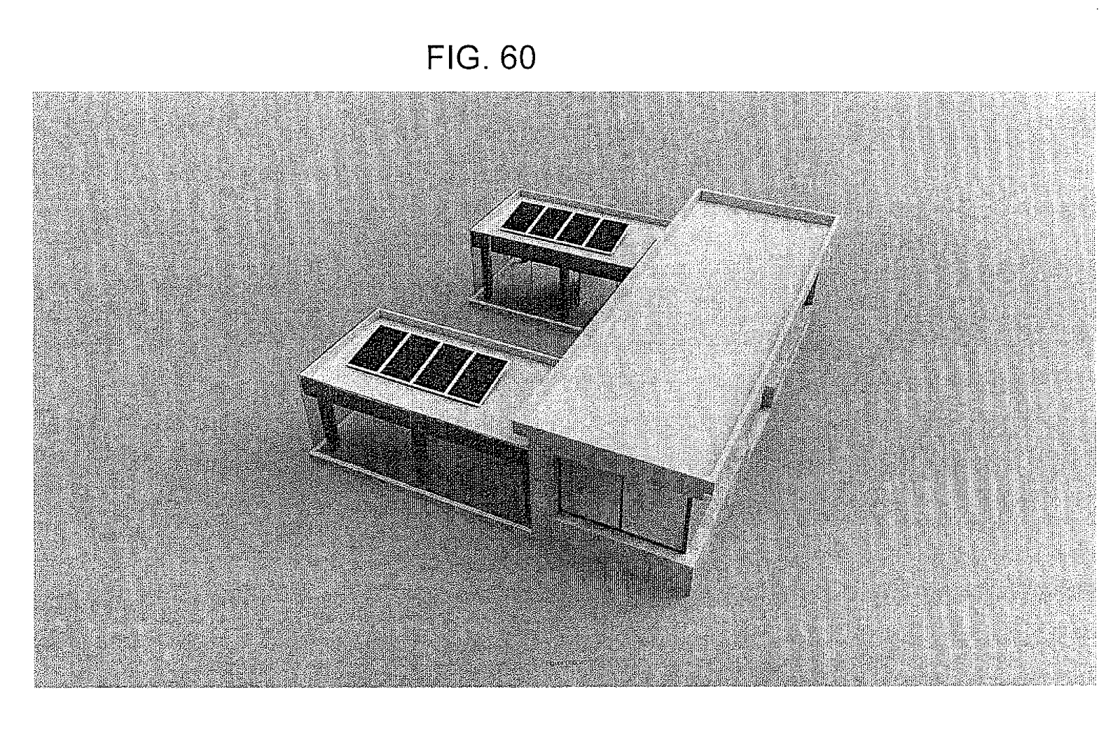

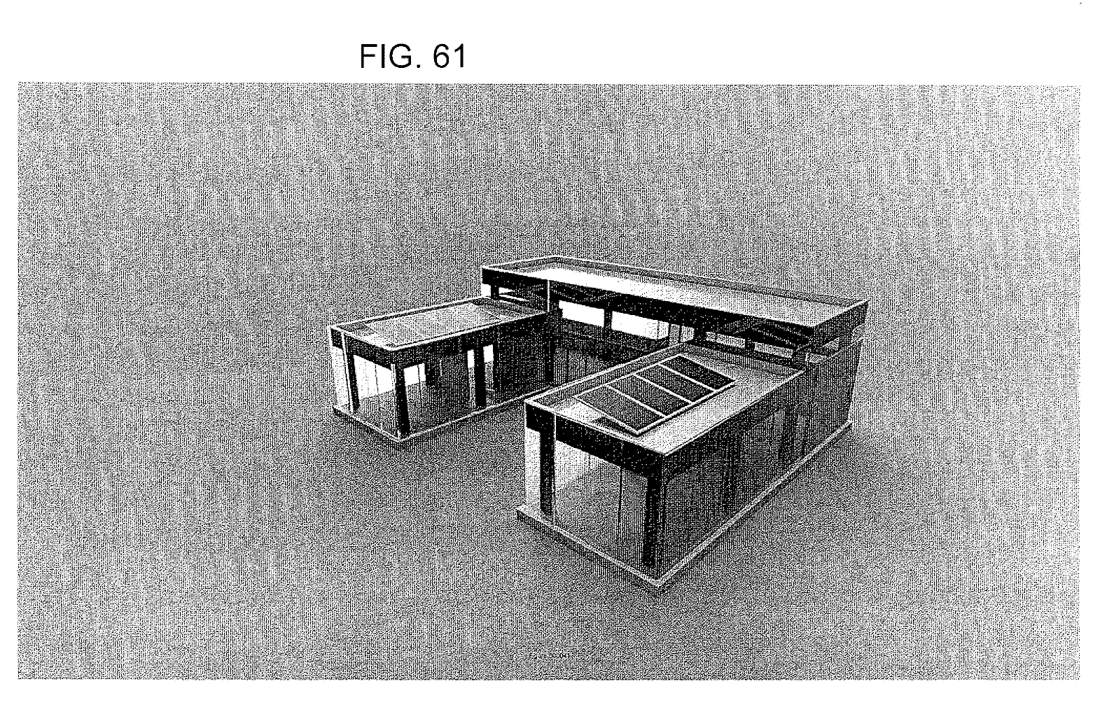

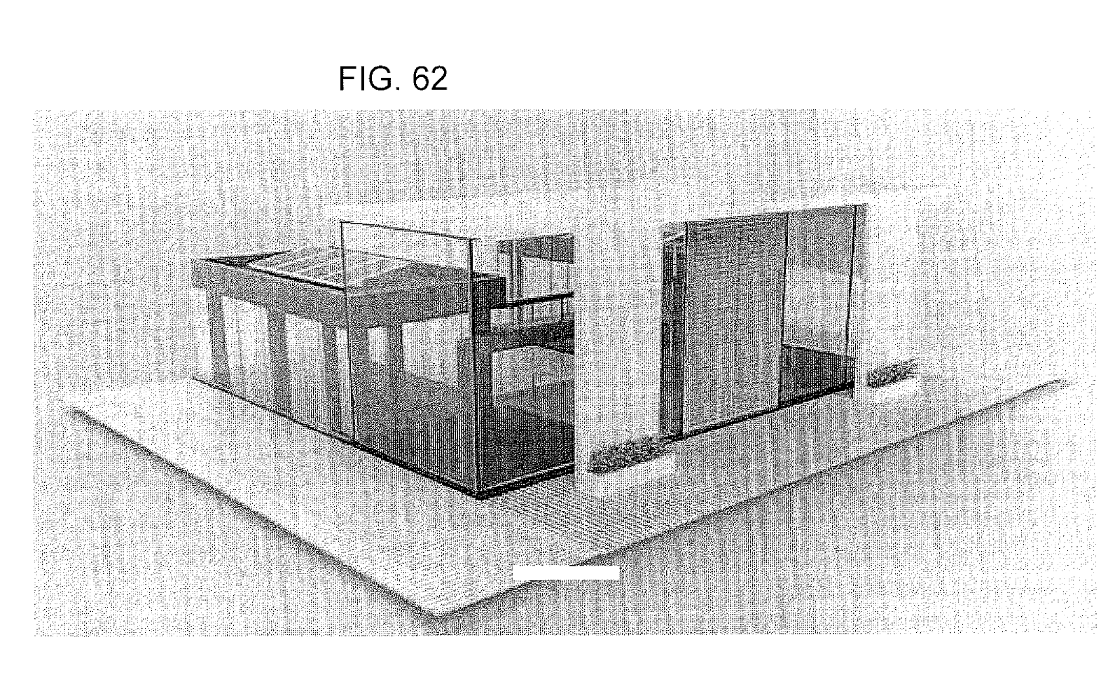

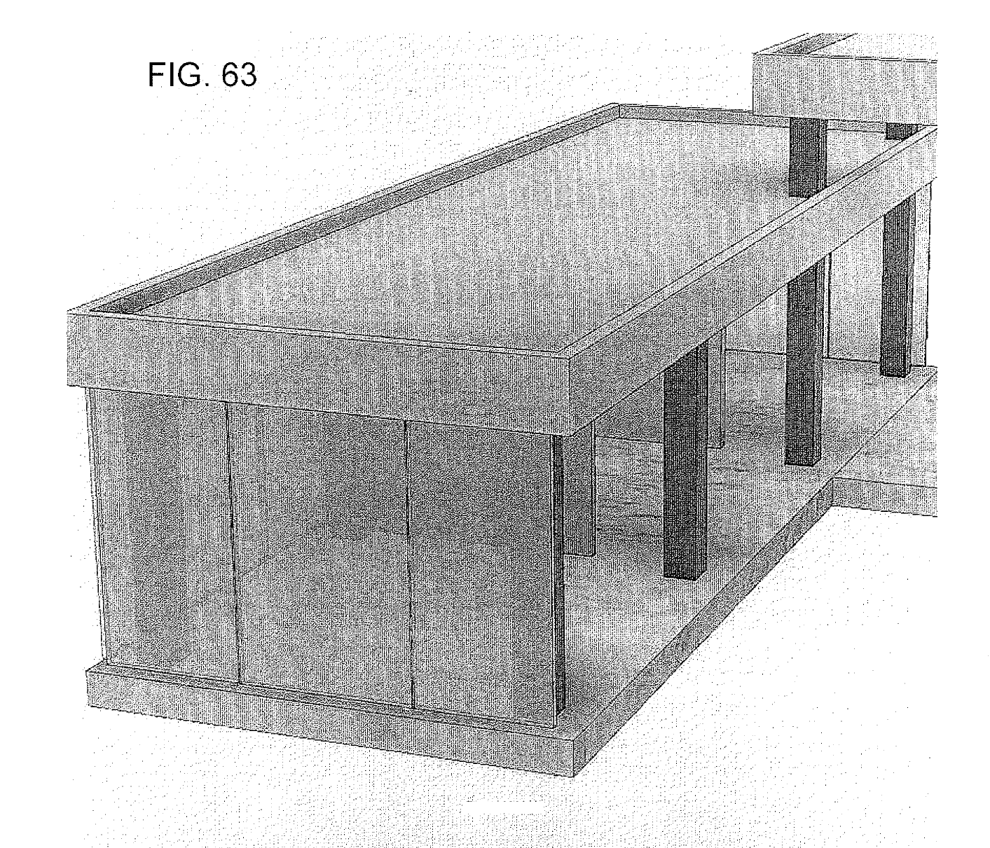

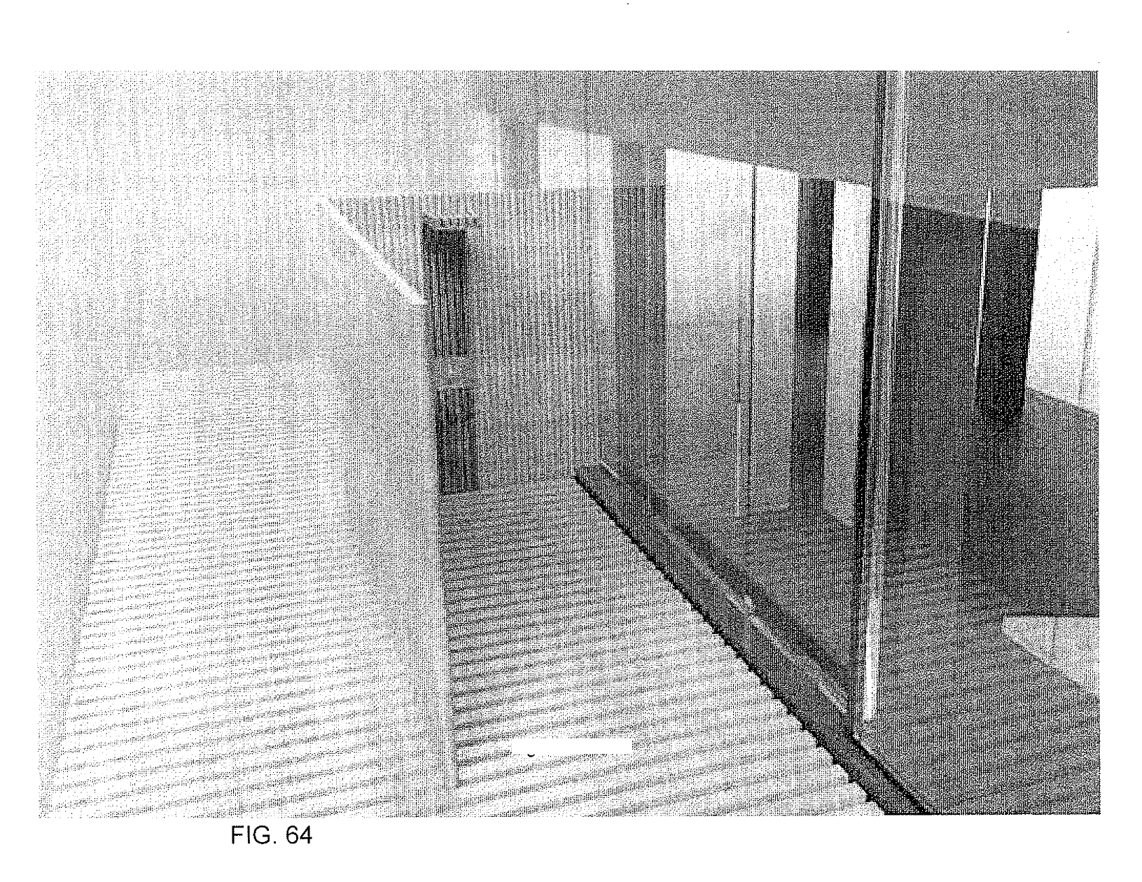

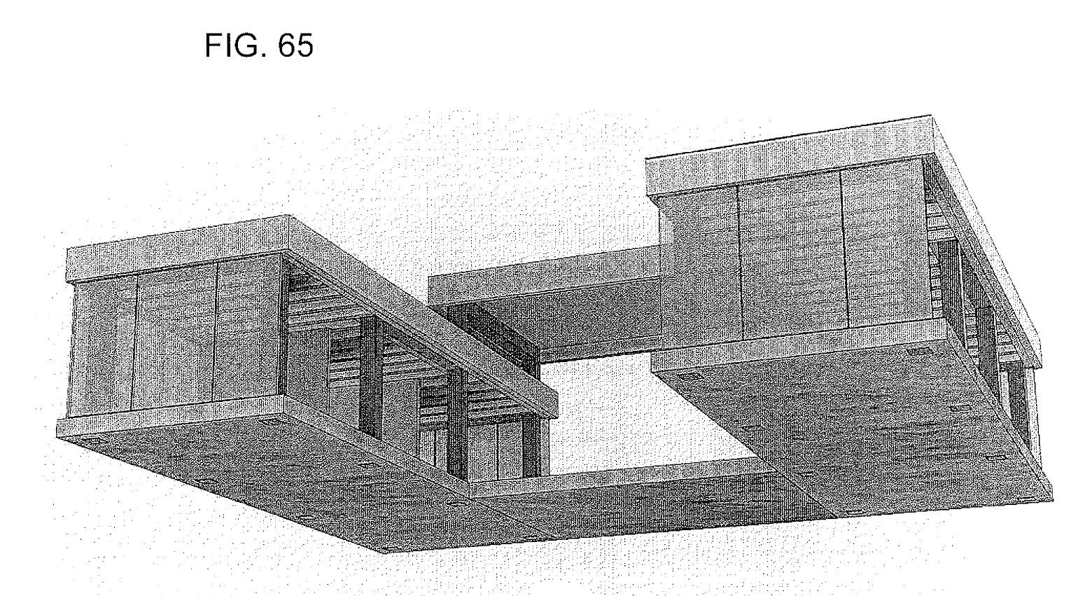

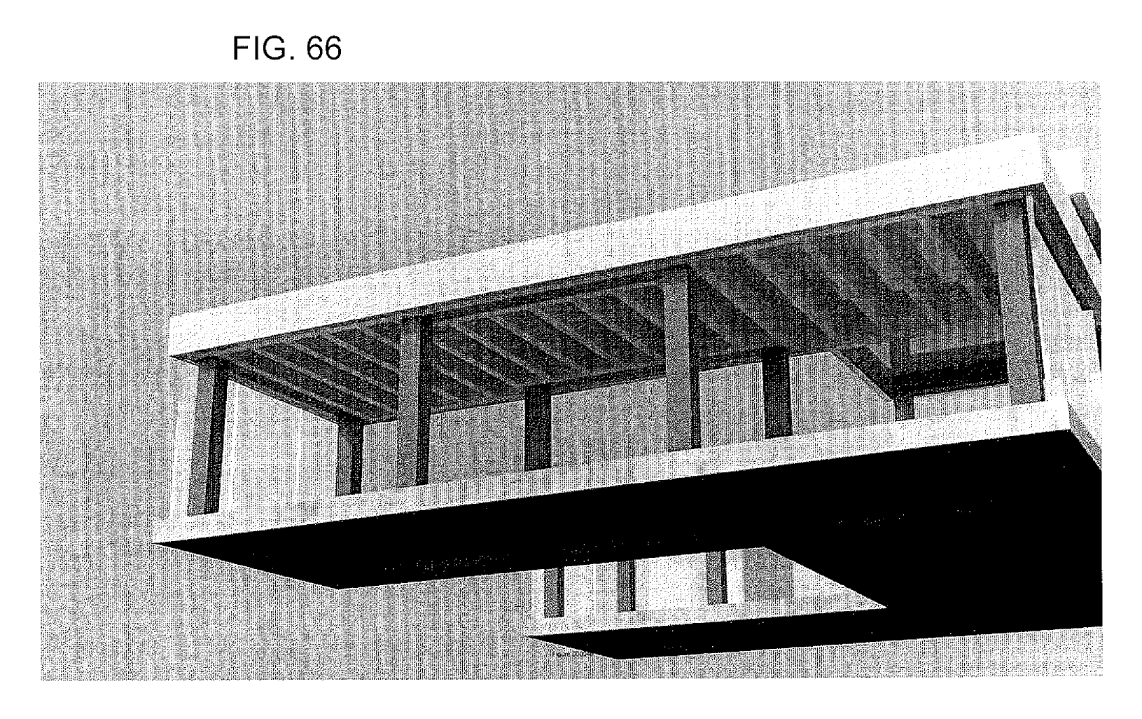

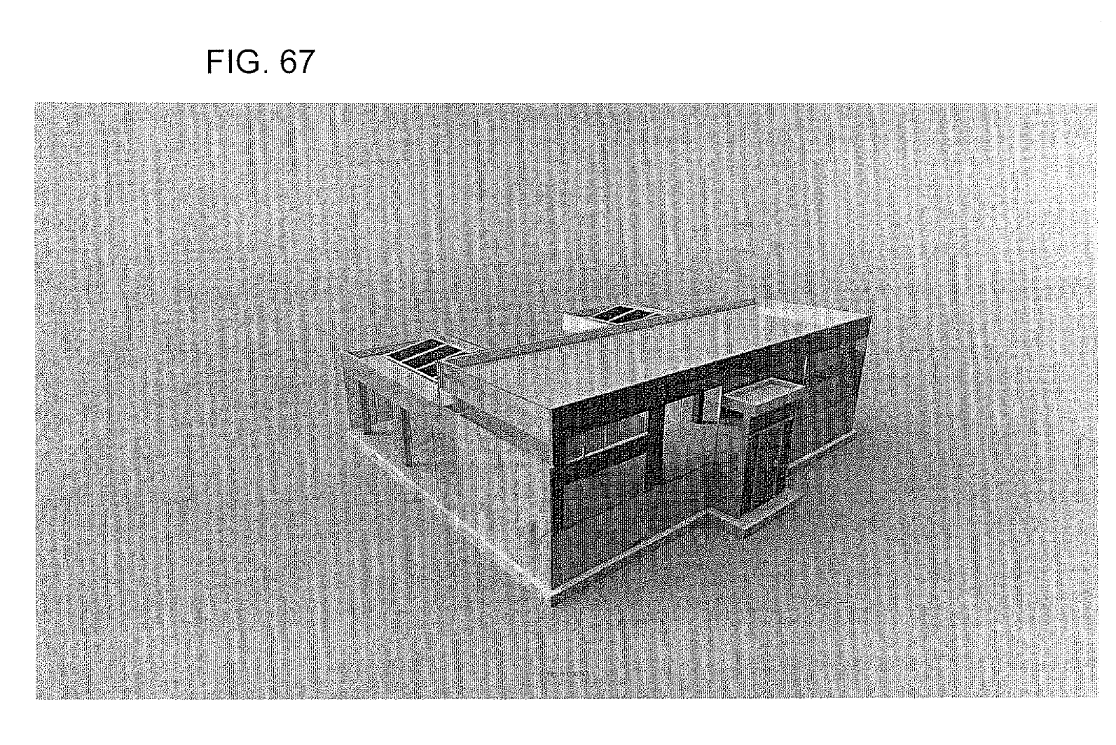

In an embodiment of the present invention, utilizing the electronic devices discussed above, a user of the present invention may access system 300 as illustrated in FIG. 3, and may be provided access to GUI 310 where additional access and instructions on use of the present invention may reside. Through at least one credential, a user may obtain access to the user layer 311 which may be tailored to each user and store relevant information gathered from the user through the GUI 310 layer or other means, as would be appreciated by those skilled in the art. Within user layer 311, the system may provide access to tools and other interfaces which may allow a user to virtually construct a dwelling, for example, in at least a 3D, virtual reality and or augmented reality and or plain view (see exemplary FIGS. 10, 13, 16, 17, 18, 25, 30, 41-45, 49-53, and 56-67). As used herein, the term “dwelling” may also include various other types of shelters, such as, by way of non-limiting example only, apartments, recreational spaces, government spaces, community spaces, retail spaces, temporary housing, hospitality spaces, medical treatment spaces, restaurants, military spaces, data centers, car ports, temporary shelters, and any similar usage which may require a structure having at least a partial surround and/or roof.

For example, a user may enter information about the site where the structure is to be built and/or may enter an address wherein the present invention may access third party information sources to retrieve the necessary property information. This information may include, for example, property dimensions, gradient levels (slope), topography, easements and other property restrictions, title, permits, weather data, soil type, available utilities infrastructure, and other related and relevant information. With or without property information, a user (could be a layman) may use the tools of the present invention to begin designing a home (dwelling or other structure) and may pull into the design fixtures, floor and wall options, and other items found in a home dwelling through the supplier layer 312. Whether local to the present invention or housed remotely, supplier layer 312 may have access to any variety of fixtures, appliances, paints, flooring, cabinets, countertops, wall materials, roofing, and electrical and plumbing supplies, for example, as may be stored in supplier goods 320. Indeed, as would be appreciated by one skilled in the art, anything that may be need for a home, for example, may be accessible, at least first, virtually through supplier layer 312. The supplier layer 312 may be considered an “open API” and may allow for third party suppliers' apps and related functionality which may open the present invention to design assistance and/or products from third parties.

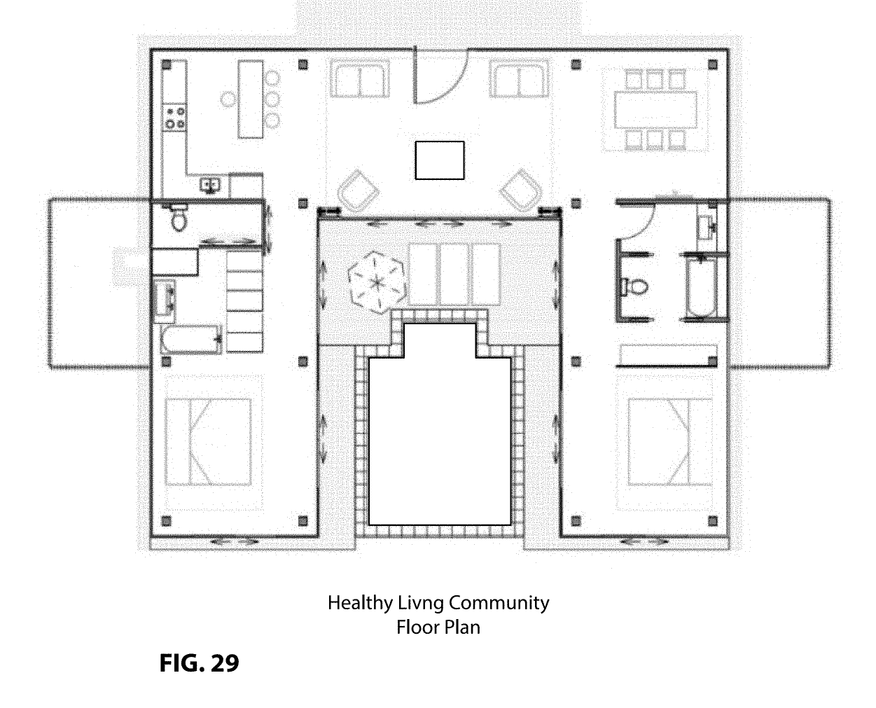

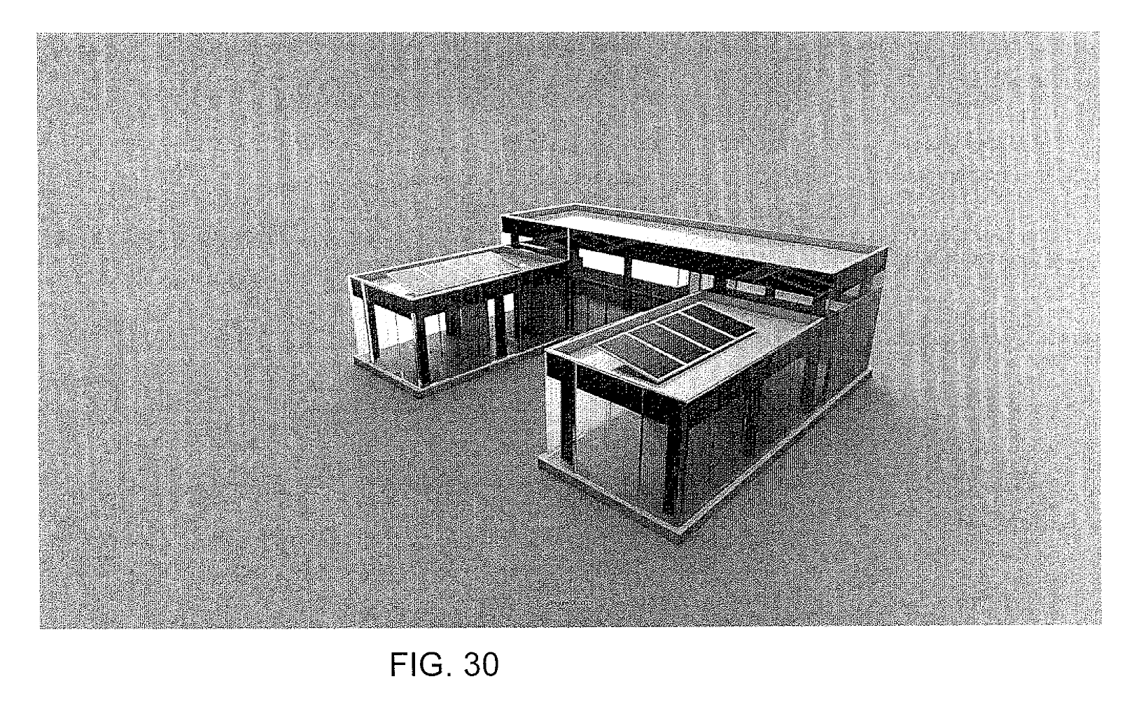

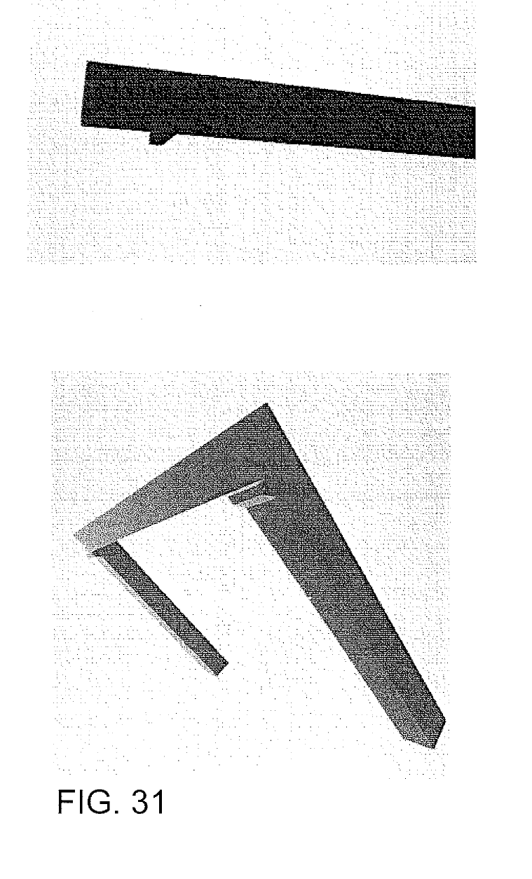

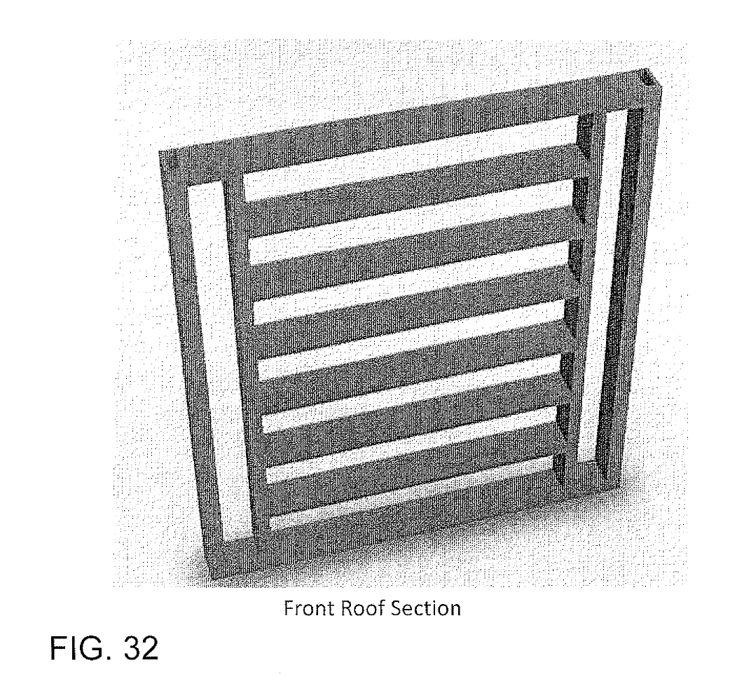

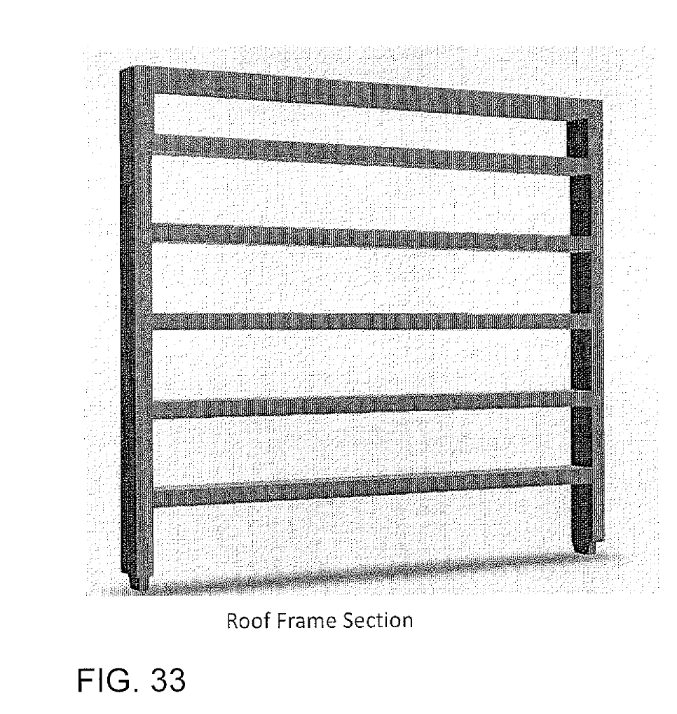

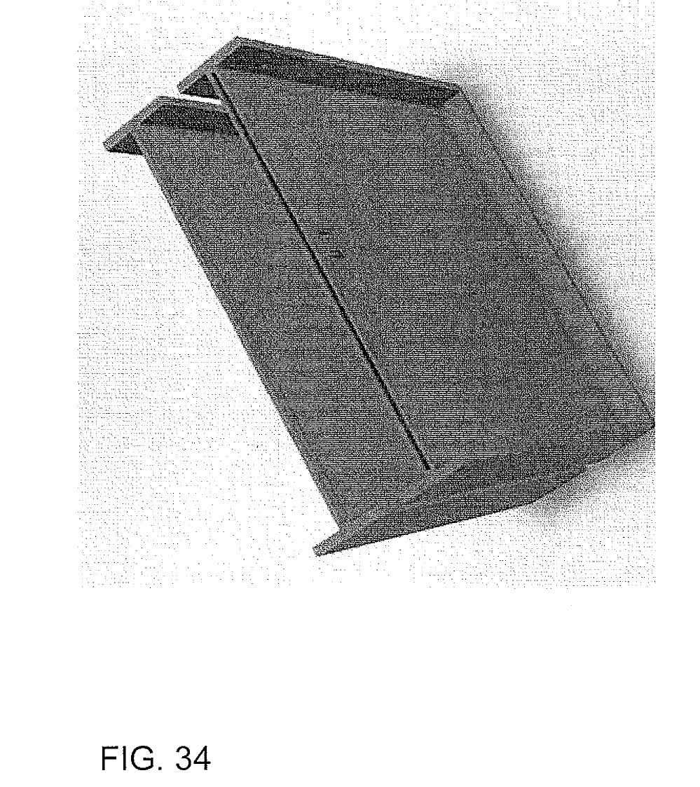

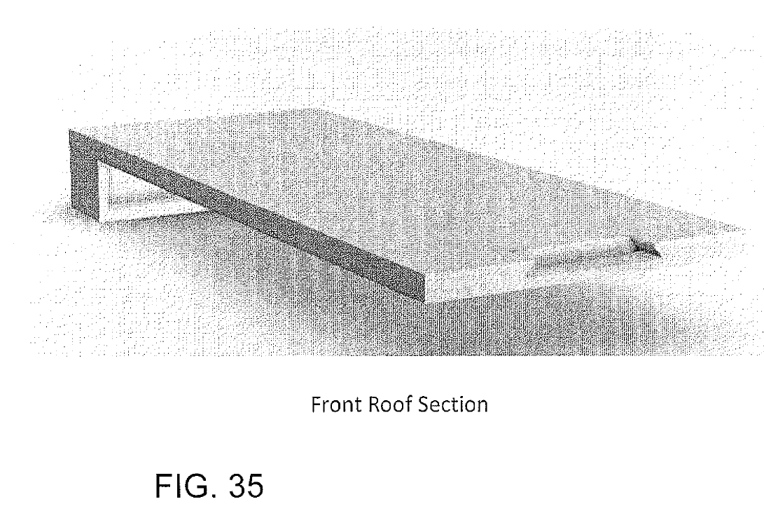

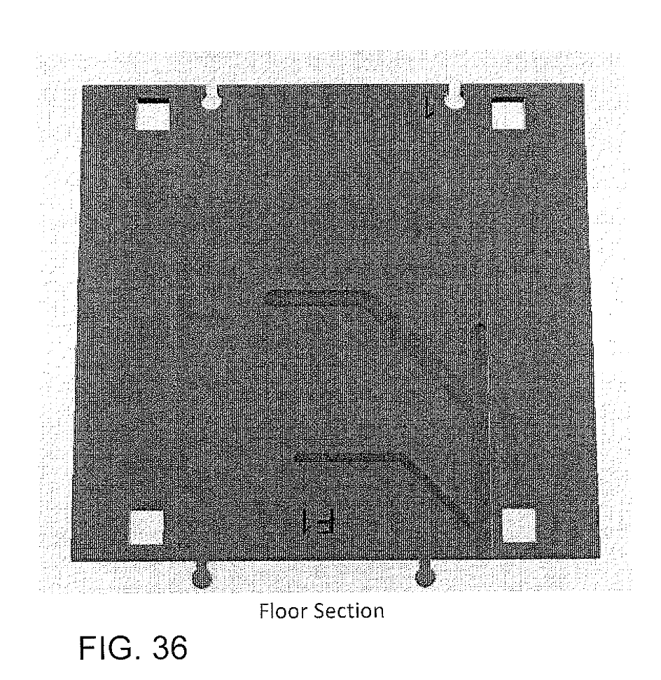

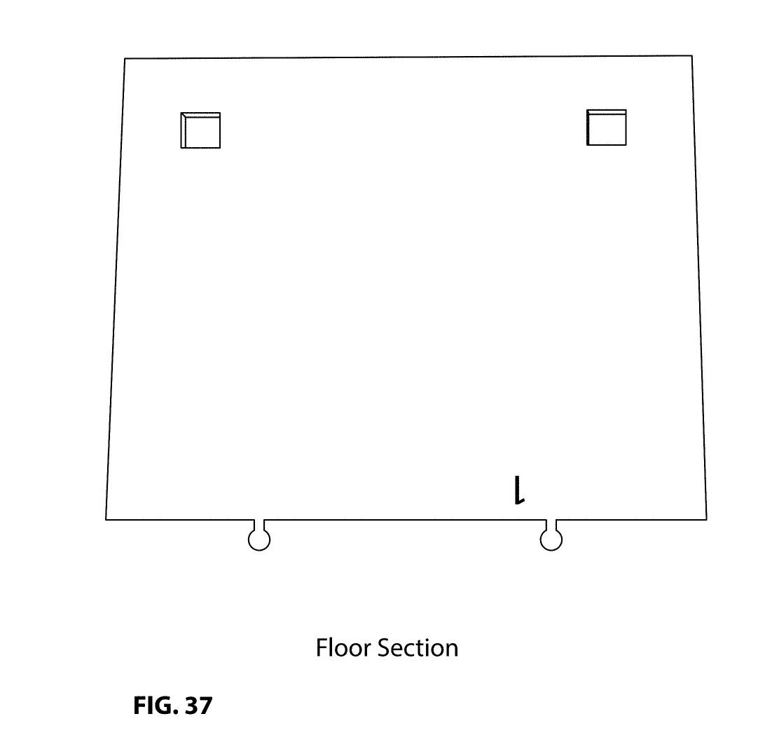

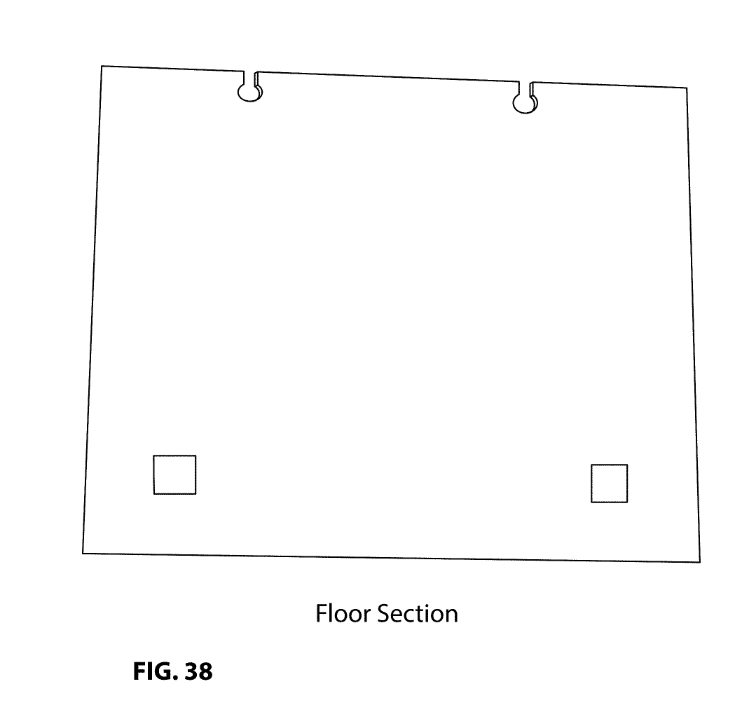

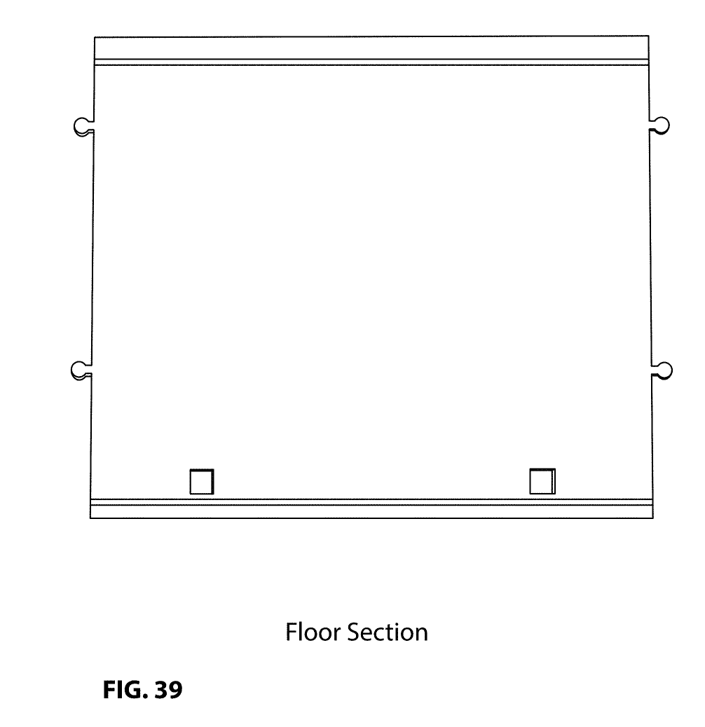

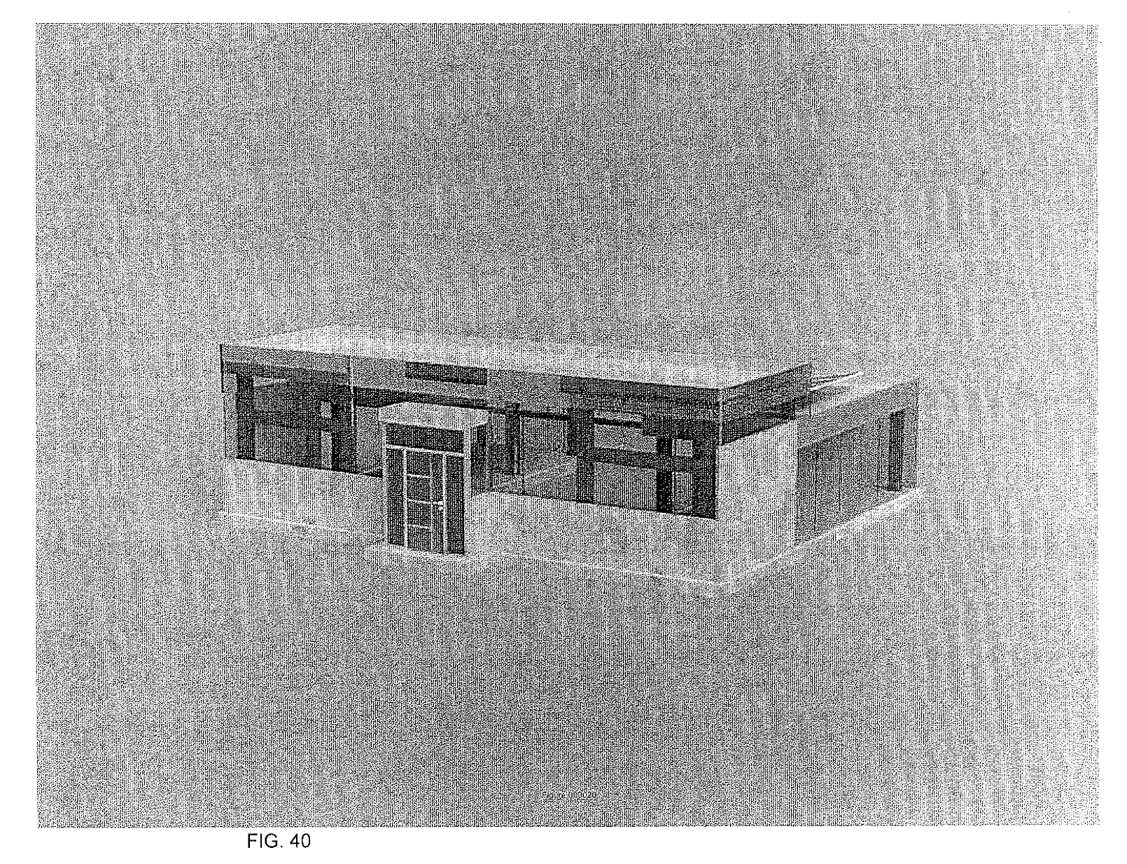

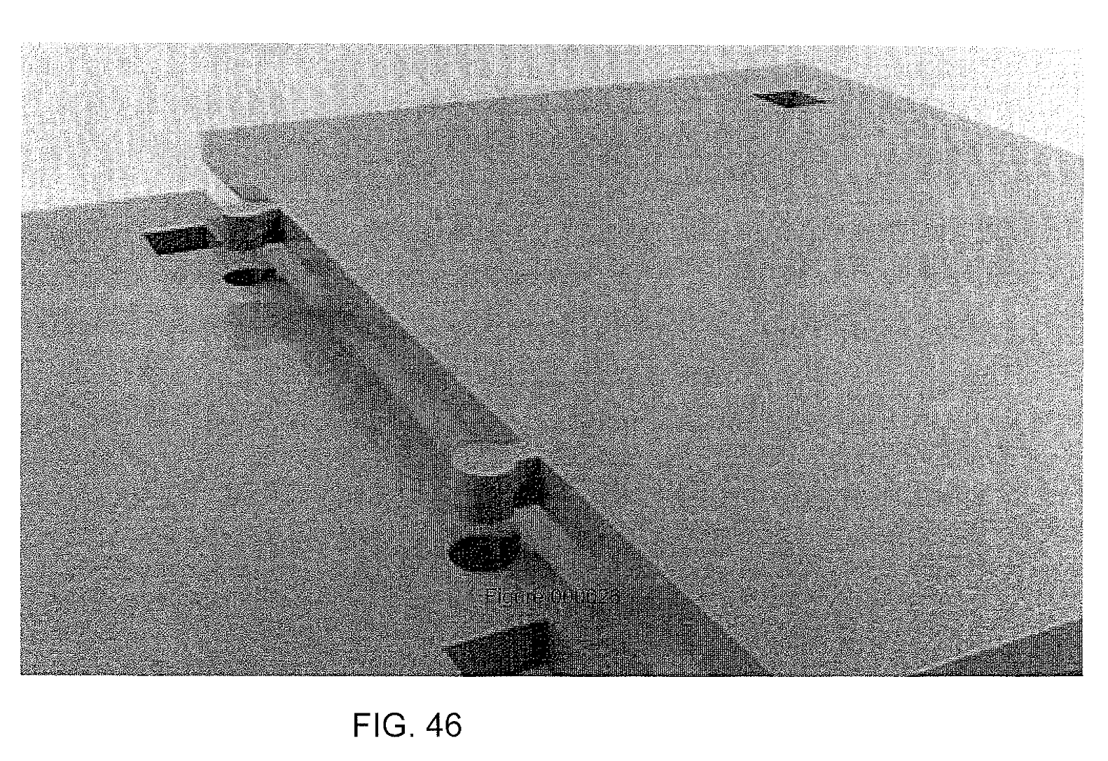

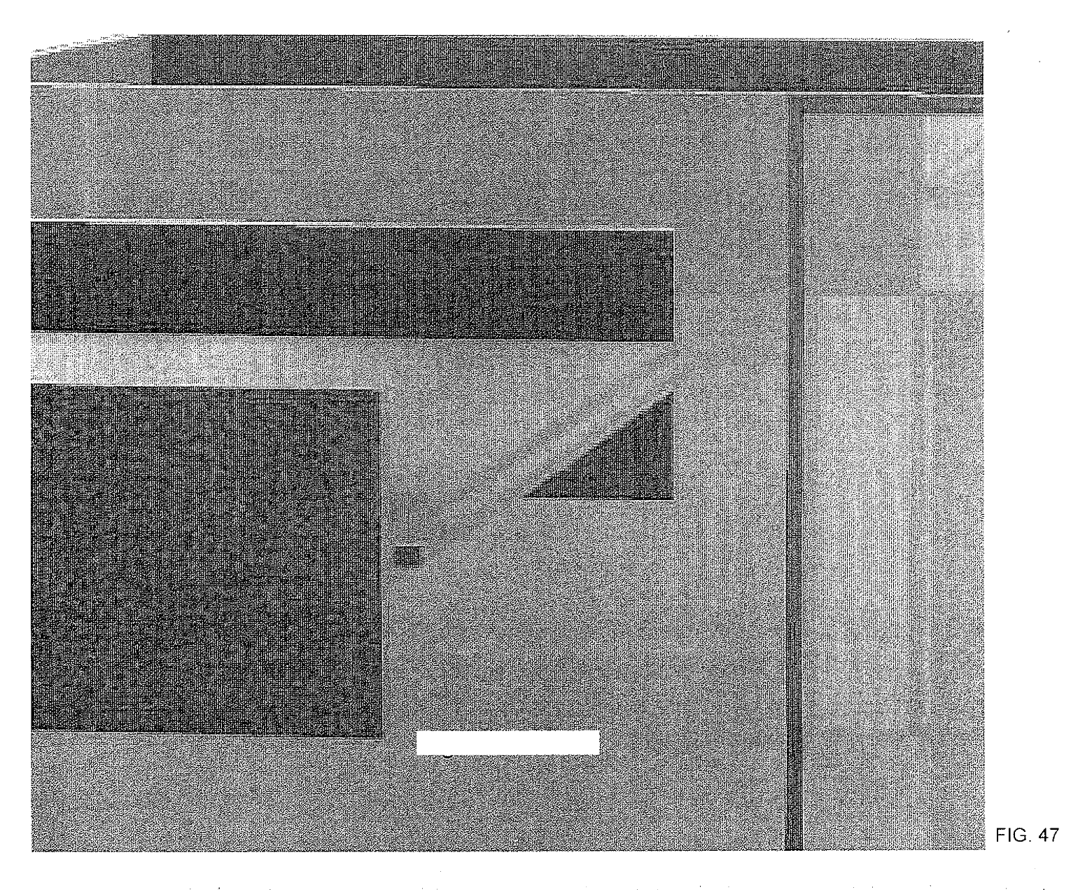

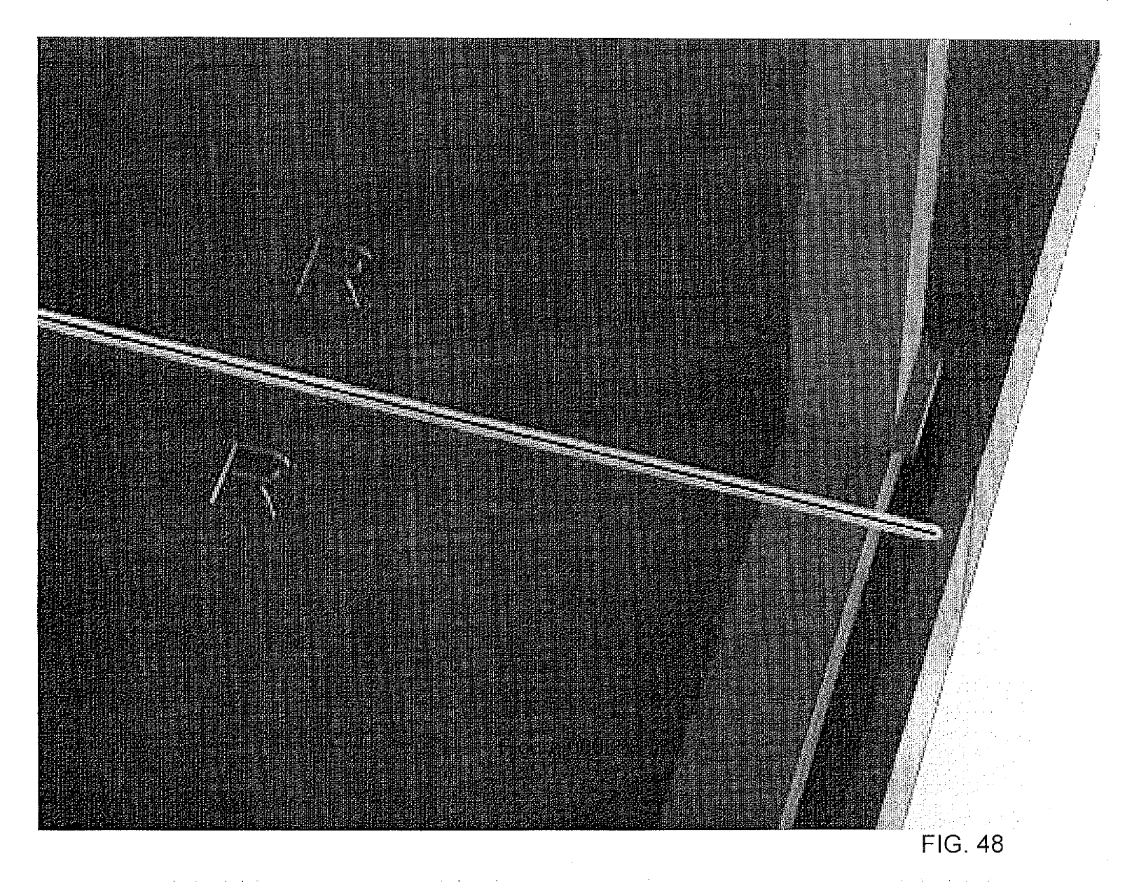

Examples of parts supplied post-design are illustrated in FIGS. 31-39 and 46-48. FIG. 29 illustrates an exemplary floor plan that is not meant to be limiting. Elements of the floor plan may include living areas, sleeping quarters, dining areas, food preparation areas, and recreational areas. FIGS. 30, 40-45, 49-53, and 56-67 illustrate 3D rendered models. FIGS. 31-39 illustrate exemplary elements that may be delivered for assembly. FIGS. 46-48 illustrate exemplary pieces for interlocking and assembly.

As the user is selecting and building a virtual dwelling, for example, supplier goods 320 may be offered to the user driven by user attributes, including interface usage, and may be driven by ad generator 325 associated with supplier goods 320. For example, a user may be selecting a flooring of bamboo from those selection offered through supplier layer 312 and may be presented with an additional choice of, for example, a cork floor through data analysis associated with ad generator 325. Generally, offers provided by ad generator 325 will be associated with materials and things available to the user through a supplier associated with the present invention.

A user may also be presented offers for items not otherwise associated with constructing of the dwelling through 3^{rd} party ad generator 330, which may, for example, provide offers for goods and services which may not be immediately tied to the development of the structure. For example, the 3^{rd} party ad generator 330 may offer to the user complimentary household goods, for example, such as hanging lights, linens, ornamental wall hangings, and the like. The 3^{rd} party ad generator 330 may also provide information related to services which may be consumed by the user, such as survey professionals, foundation services, and landscapers, for example.

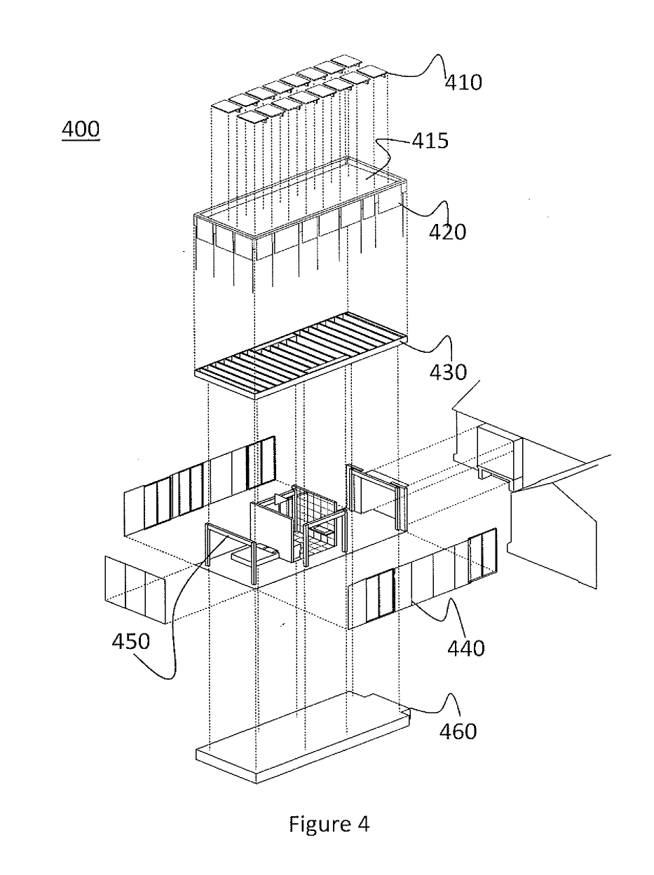

Once a virtual dwelling has been at least partially completed, manufacturing 341 may be given a purchase order, for example, to begin constructing the dwelling. The dwelling may be constructed in a single remote manufacturing facility and may be piecemeal constructed and designed to be assembled remotely on the user's defined property. As illustrated in diagram 400 of FIG. 4, several larger aspects of a dwelling are shown. The base component of each dwelling may include at least a portion of moment frame 450, which may include, for example, three high strength components, made of material such as steel, which may, when joined to other frames, create a portion of the structure on which a majority of the other components may be reliant and/or affixed.

During erection of a structure, as will be discussed below, a portion of a moment frame 450 may be affixed to a floor 460 and may be further affixed to a plurality of moment frames. Floor 460 may be comprised of concrete. From a moment frame 450, walls may be hung or affixed and may include interior walls and exterior walls. Exterior walls may come in the form of windows 440 and may include, for example, sliding glass partitions, doors, frames, and other aspects associated with modern exterior coverings incorporating a large amount of glass. Interior walls may be constructed using traditional gypsum board materials, PVC materials, fabrics, press formed sheet products, metals, and the like. The choice of material will favor those that are lighter in weight and which provide high durability. The interior wall materials may come affixed to portions of a wall truss system, such as the use of studs, which may for example, be made of aluminum, to ease the installation process and to make the interior wall material more easily transported without damage.

In an embodiment of the present invention, a dwelling may be a single story high and may, for example, have a small pitched roof. The present invention may also allow for stacked units and may, depending on the materials used, allow for over five (5) story high structures, though the technology and method allows for assembly of structures higher than five (5) stories. Roof framing 430, which may come in various sections, may be assembled and affixed to the top of moment frame 450 and may accept a roof covering 415 which may include an independent frame support, for example. The roof covering 415 may include any known and suitable roof material and may include, for example, solar panels 410. The roof, and therefore dwelling, may also include recycling systems such as but not limited to solar, water, irrigation, thermal energy, so that the dwelling may be fully or partially autonomous and independent of a grid. These additional systems may include water catchment and/or gray water recycling systems, or the like. The roof covering 415 may also have incorporated therein aspects of at least one cooling system which, for example, may be communicatively connected to an electrical source and/or condenser as necessary. Similarly, guttering aspects and/or other means of drainage may be incorporated with roof covering 415. Attached to the exterior of the independent roof support associated with the roof covering 415, for example, may be roller shades 420 which may provide protection to the interior of the structure from the outside elements.

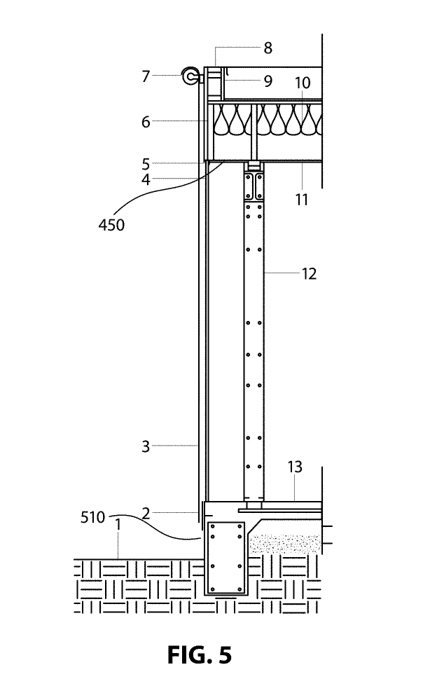

As illustrated in FIG. 5, for example, moment frame 450 may be constructed using an “I” beam formation and may provide support for a second story as well as an exterior overhang portion. The moment frame 450 may be attached to foundation 510 which may, for example, take the form of a monolithic slab. Although flooring, including the use of concrete, may be placed on top of the foundation 510, the top surface of foundation 510, when made of suitable concrete, may be polished and or otherwise treated for use as a floor in the dwelling. In this way, no additional flooring is necessary for the dwelling to be suitably functional as a living space. Of course, as would be appreciated by those skilled in the art, conventional floor coverings, such as tile, hardwoods, composites, rubber, synthetics, carpets, and the like, may be used.

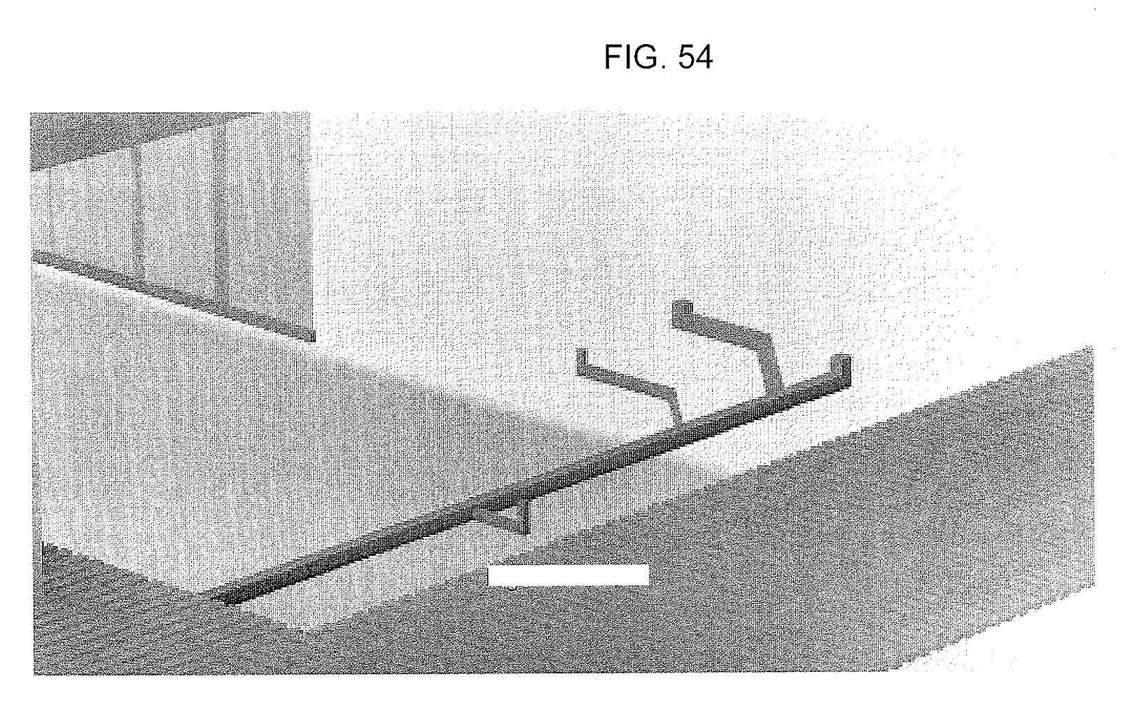

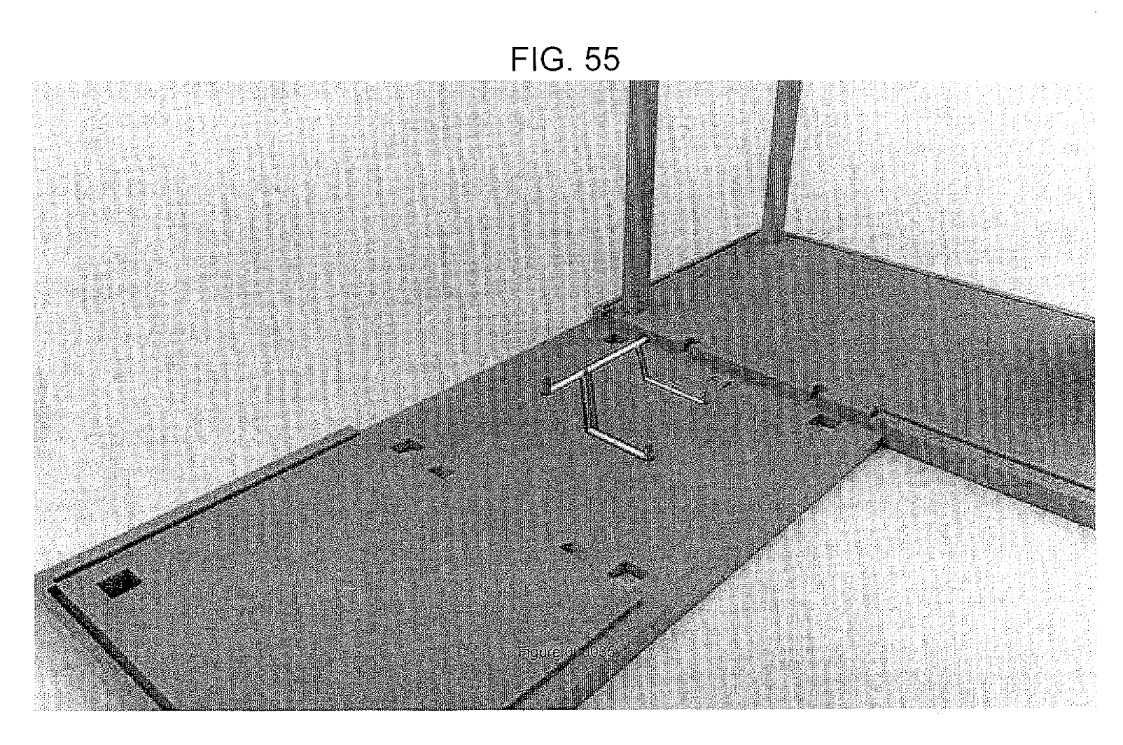

In an embodiment of the present invention, the foundation(s) and roof system(s) may comprise a majority of the utilities associated with the structure and may, for example, contain control mechanisms for each system and subsystem. Exemplary piping is shown in FIGS. 54 and 55. Utilities may be fully contained within the foundation and/or roof, or both, of the dwelling. Utilities contained within may include, but are certainly not limited to, water pipes, electrical, HVAC, radiant heat, and cooling systems. In at least one embodiment, a foundation may be built utilizing a stencil-like mechanism. The stencil-like mechanism is interconnected and forms the shapes that include all the sheathing pipes for all utilities. For example, a radiant heat may be embedded in the foundation and may be inclusive of, for example, a heat pump or other device which may drive the radiant heat system. Similarly, the roof system(s) may have embedded therein cooling systems capable of cooling at least a part of the interior of the structure(s). Each of these systems may be a closed system in either the foundation and/or the roof system or may be interconnected into additional system aspects otherwise included in an at least second portion of the structure. As would be appreciated by those skilled in the art, the systems discussed above may be controlled by conventional wired based user controls, wireless controls, and/or Wi-Fi based systems, such as mobile apps, for example.

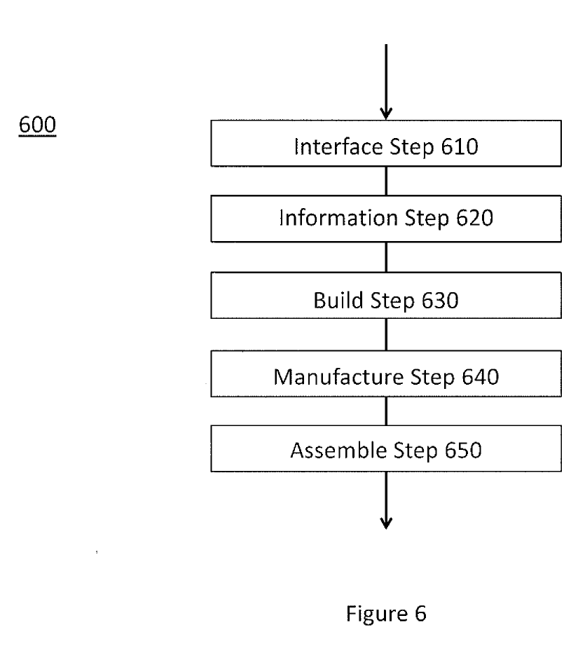

In an embodiment of the present invention, a dwelling may be purchased through a web interface and may be shipped for assembly to a remote location. For example, as illustrated in FIG. 6, steps 600 illustrate the simplicity provided to the customization and ultimately erecting a structure on a remote site of the user's choosing. The user may first access the present invention through interface step 610 which may require the user to establish a secure identity with the system and may, for example, establish the credit worthiness of the user or establish that the user has sufficient funds for at least the minimum use of the present invention. The system may then require the user to provide certain information in information step 620 which may include, for example, building site attributes, user preferences and expenditure ranges, for example.

Once the system has collected sufficient information form at least step 620, the build or design step 630 may allow a user to virtually build a dwelling to their standards, preferences and price point. The system may allow for full customization and/or allow a user to take already defined units and place them together in a desired fashion. Similarly, whole scale dwelling may be selected by merely a single selection which the user may or may not alter in anyway. Once the virtual dwelling is completed, the parts and pieces may be manufactured at step 640.

The manufacturing of the dwelling (absent the foundation and attendant utilities hookups) may take place at a single factory and may contain modular pieces. For example, the moment frames used in the dwelling may each be of the same size or sizes such that only a few choices may be provided to the user which may allow for moment frames to be manufactured independently of being ordered and/or assembled with a customized dwelling. Furthermore, the present invention may limit the height of the exterior glass, for example, to standard glass heights to keep material costs low. The greater use of standard sized materials. and products, although non-standard sizes may be used, may allow for reduced cost in manufacturing, as would be appreciated by those skilled in the art.

During the manufacturing step 640, the virtual dwelling may be prepared in true scale at the factory such and prepared for shipping to a designated location. More specifically, plans are generated from the virtual dwelling created by the user and all the requisite pieces associated with the plan are grouped for shipment and are assembled to maximize the ease of final construction. In an embodiment of the present invention, all pieces of the true scale dwelling, where applicable, are labeled, pre-drilled, and/or have the necessary mating connectors to make on-site assembly efficient and cost effective. By way of non-limiting example only, plumbing within the dwelling may be partially installed on or within various wall unit members and may have associated with them quick connect interfaces such that the plumbing may be easily interconnected as the associated wall units are installed. Electricity may be similarly run and may include quick connect interfaces with other electrical lines, as well as fixtures, including electrical sockets, or the like.

Further, the packing of the dwelling materials into one or more shipping containers may be dictated by their removal from the shipping container and may be in concert with the building plans. A “first in, last out” approach may allow for more efficient on-site assembly and may allow for materials not yet in place to remain protected in the shipping container and/or not otherwise unnecessarily disturbed. Each component may have a label in the form of a RFID, Bar Code, English or other language instructions as needed, attached both on the packaging and on the component so that an assembler who scans the label will be permitted to take it out only in the correct order and that the time is recorded and monitored from the first time the label is scanned. Each component may have a measurement of time for completion so that an entire job is pre-calculated with respect to how much time it should take for assembly. Inclusive with the materials may be all necessary hardware and tools to complete assembly. Although it may be preferable for a local contractor to prepare the site and install a foundation, the present invention may include, for example, concrete, concrete forms, and other tools and materials necessary to construct a suitable foundation. This may allow the present invention to be used in very remote areas or in areas where certain materials are not readily available, such as, for example, war zones and or other areas where military use of the present invention may be desired. A local foundation contractor may be provided a predesigned, shipped, stencil which may allow for the installation of a foundation having exacting dimensions. The stencil may also inform the contractor as to where to provide reinforcements and footings, for example, where to embed certain systems, and where to place necessary sleeves, and the like.

As discussed above, the assembly step 650 may include those use of plans generate in building step 630 and may be completed by at most two people thus eliminating the need of heavy machinery to pick up heavy materials. The plans and the materials may be labeled using color, numbers, barcodes, NFC tags and the like. For example, if NFC tags are used, a mobile app may be deployed to facilitate the choosing and locating of pieces in an automated fashion to speed the assembly of the dwelling and to limit the need for a professional or otherwise skilled worker in the construction field. The present invention may also provide video training and/or a large 3D model of the dwelling which may inform the user of how the true scale dwelling is to be assembled.

Assembly step may coincide with manufacturing 341 as shown in FIG. 3, and may be used through fulfilment 350, which may include the packing and shipping of the true scale dwelling. Once the dwelling has shipped, the present invention may then alert the user and provide delivery confirmation and tracking as necessary.

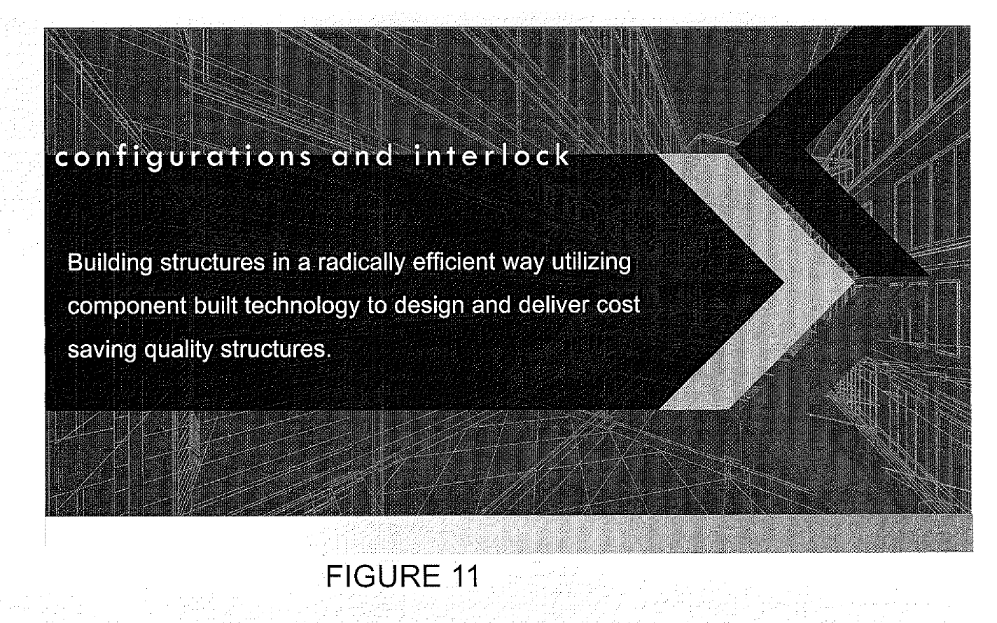

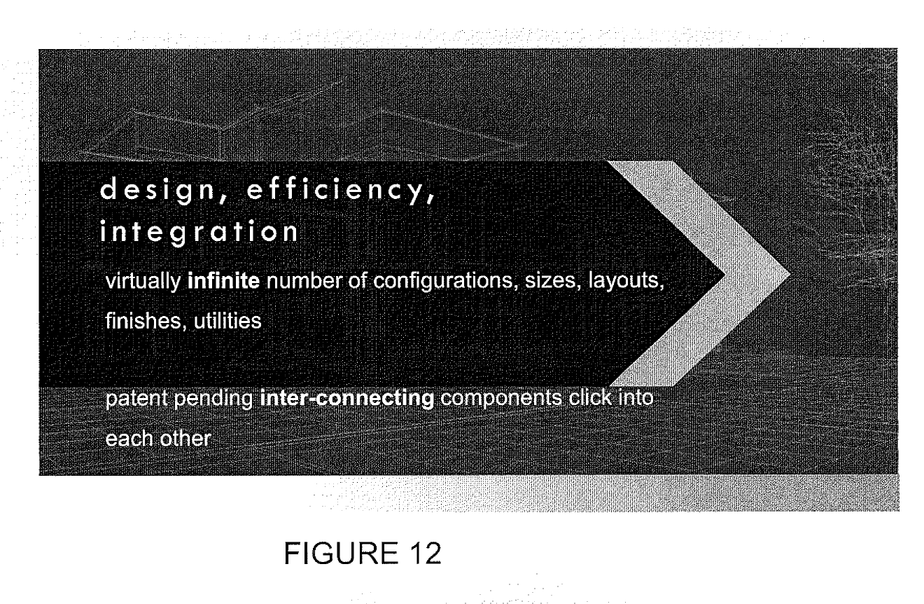

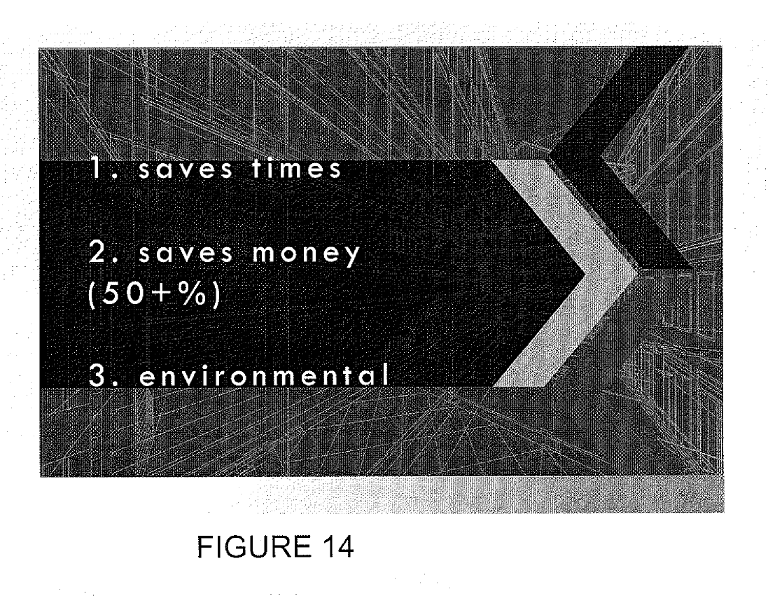

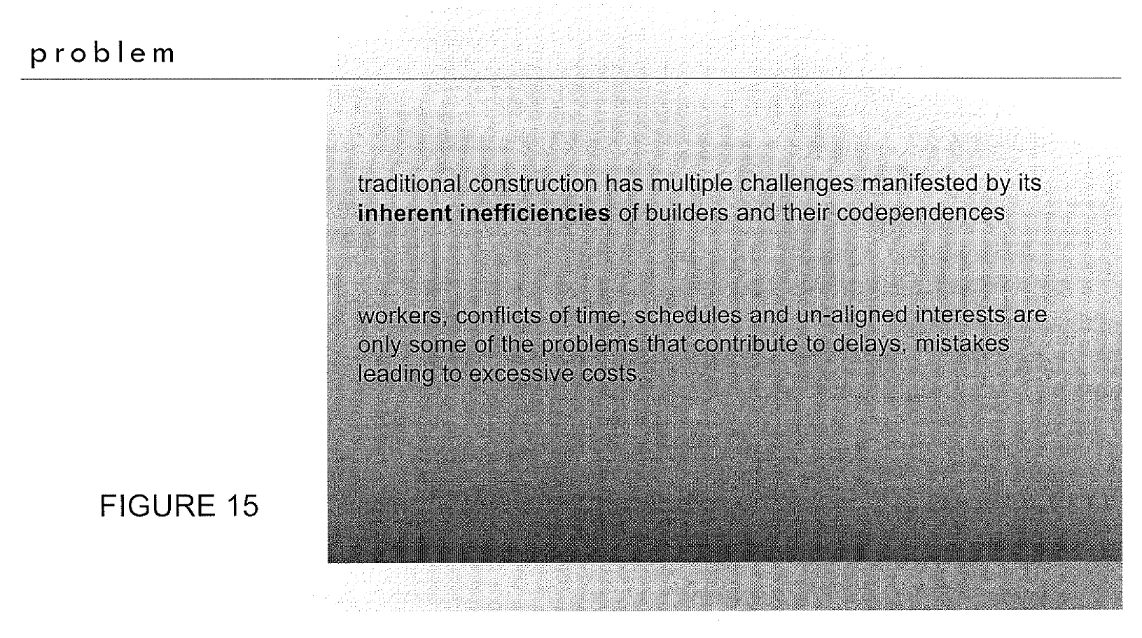

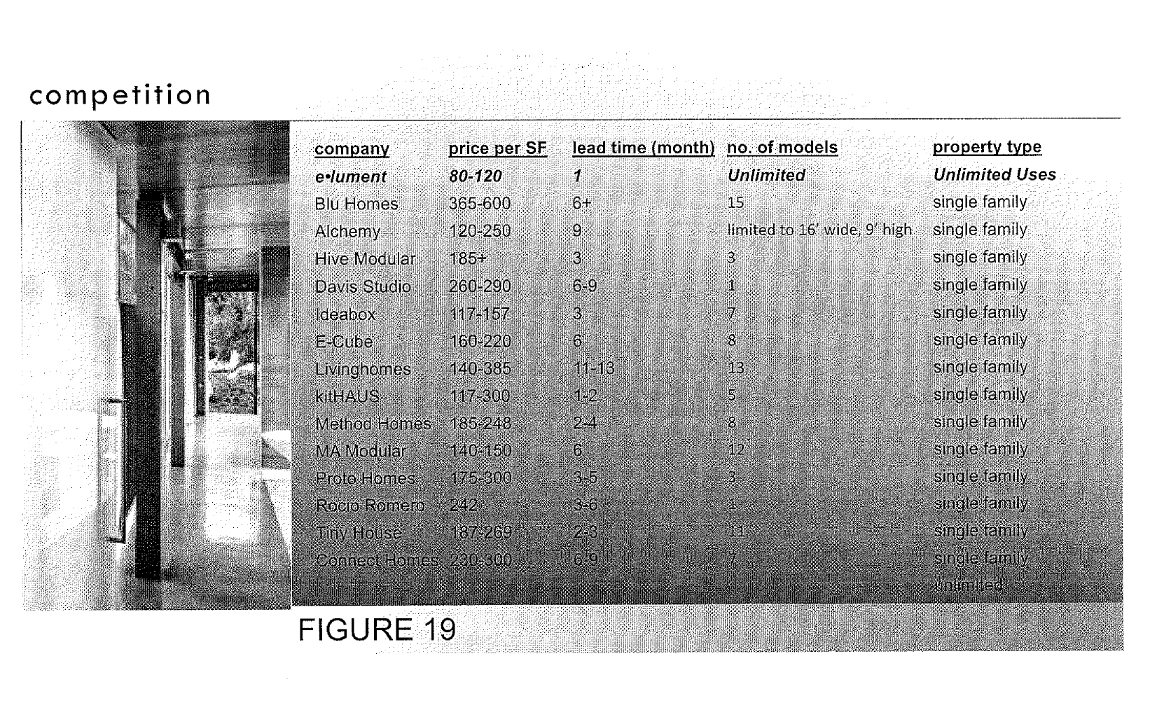

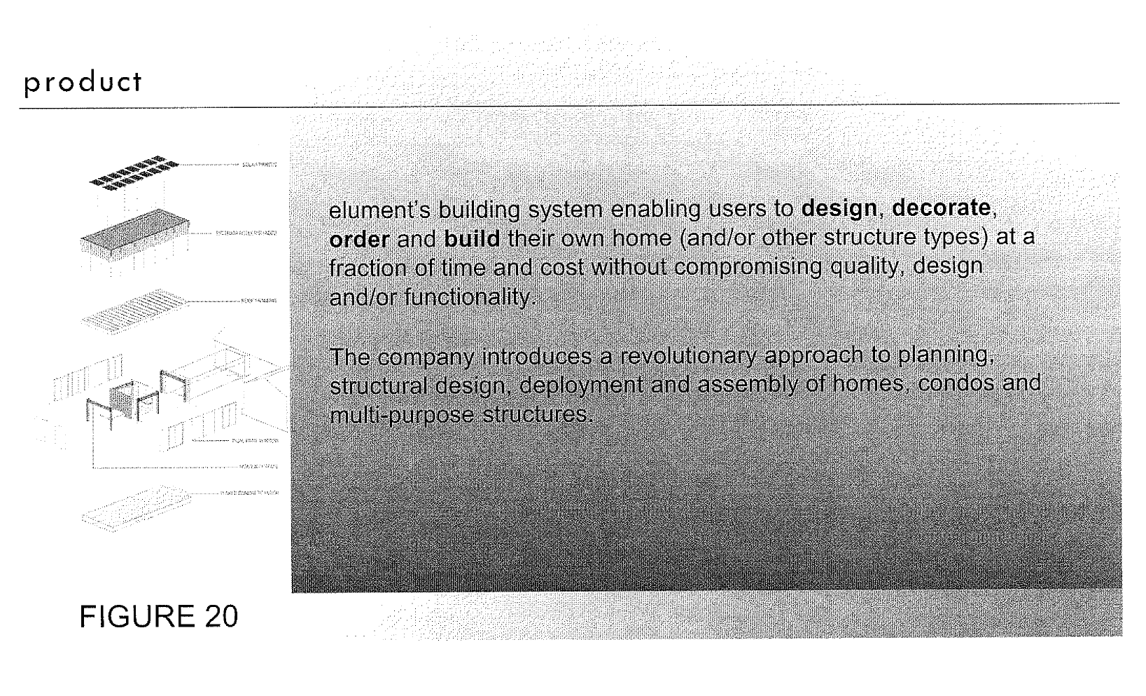

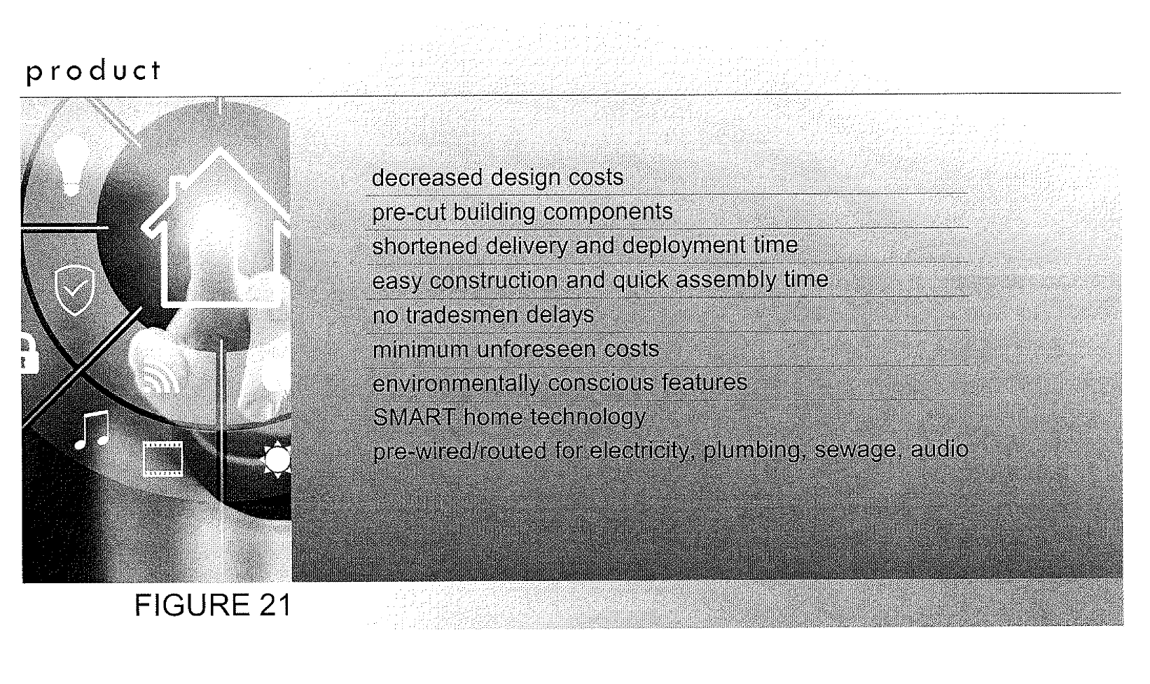

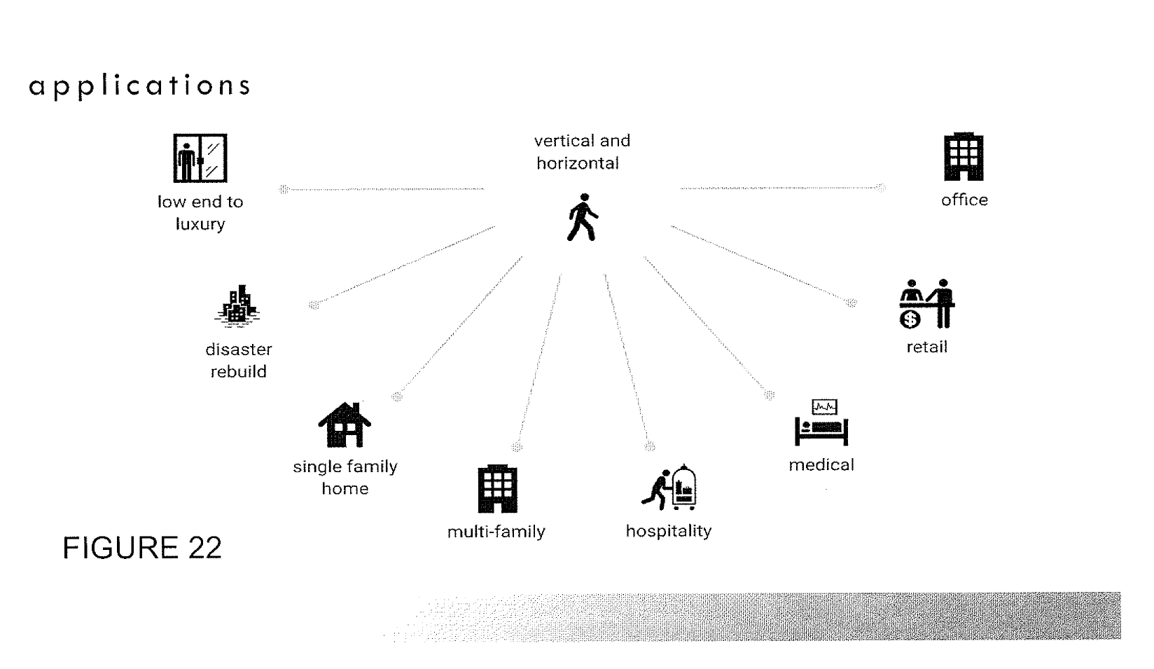

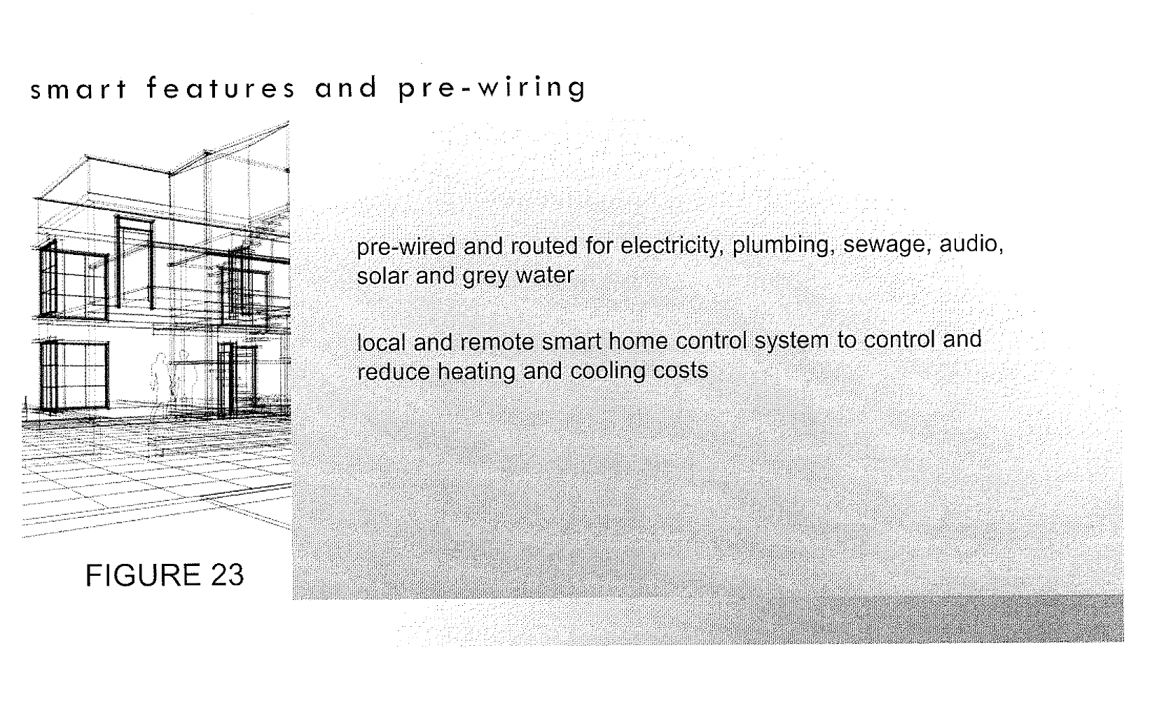

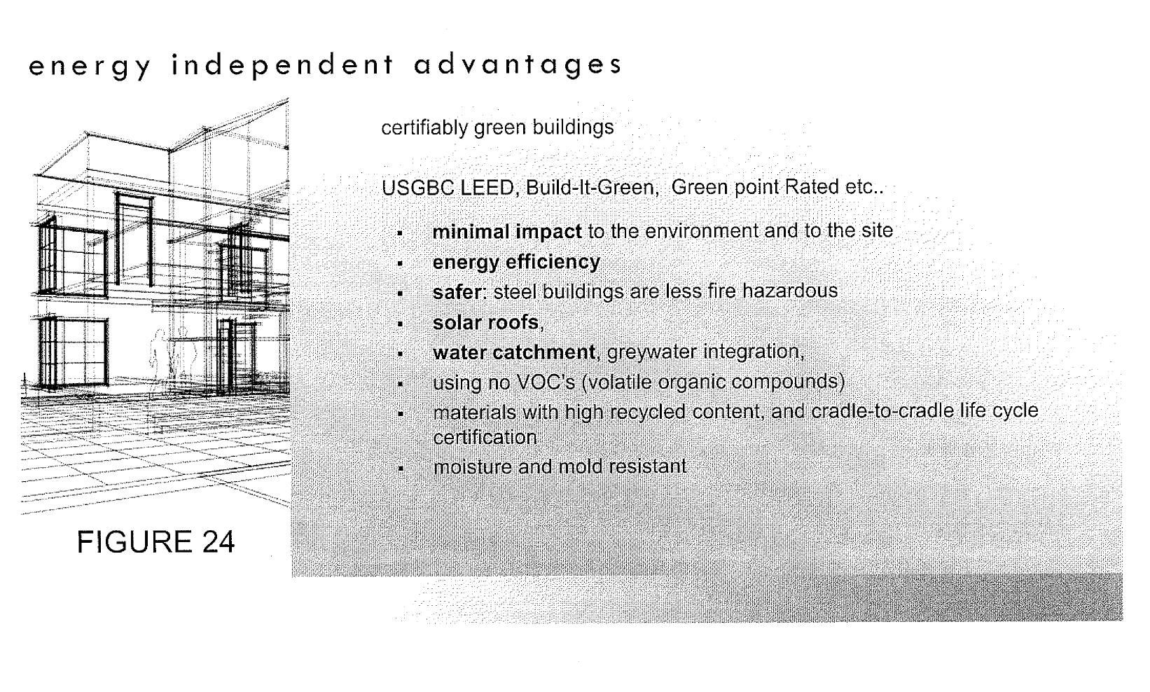

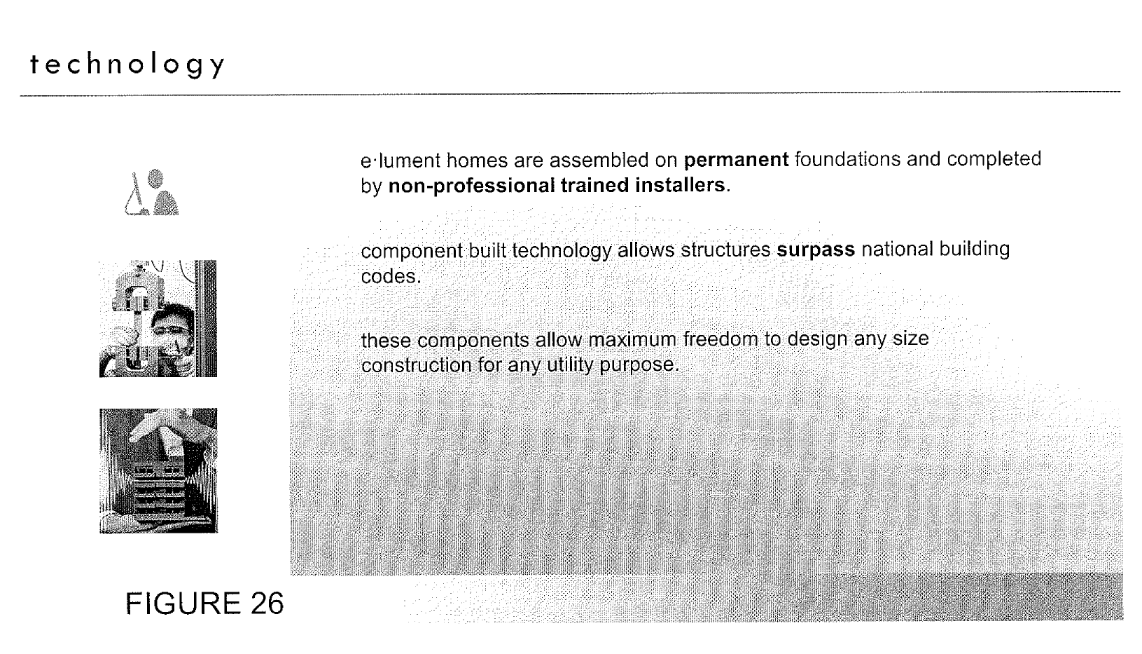

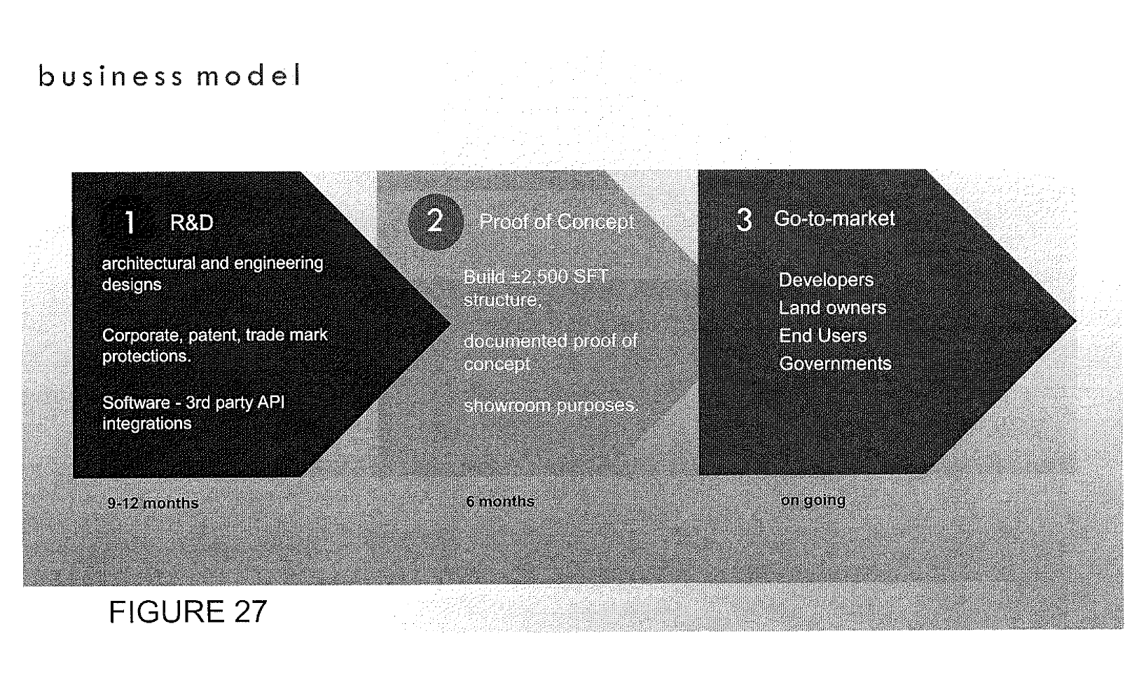

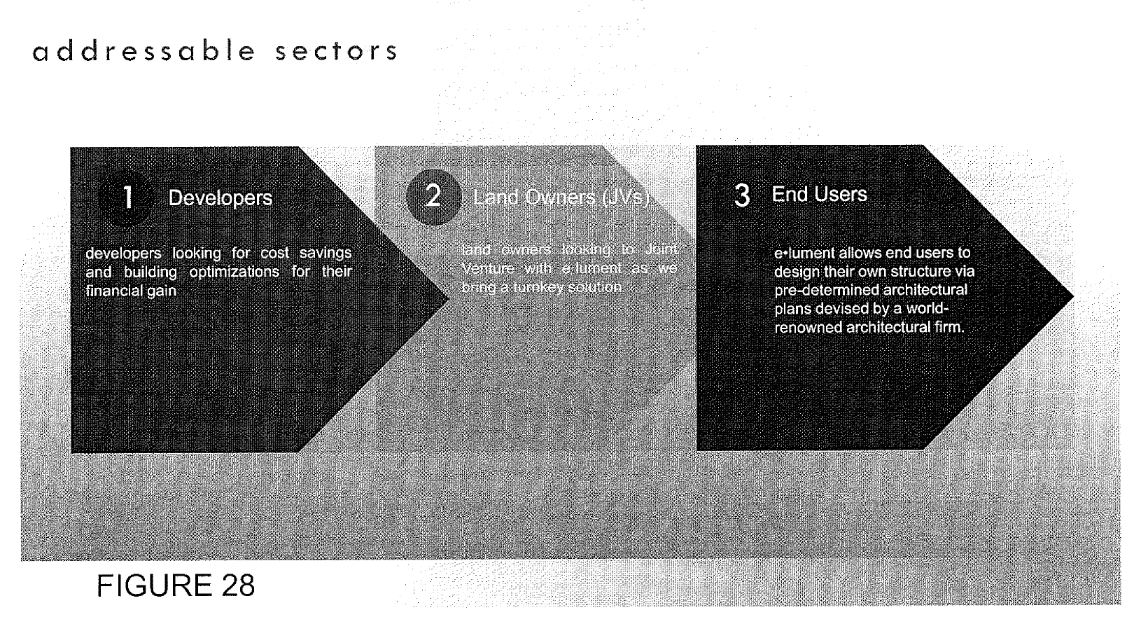

It is to be understood, using the methods set forth herein and above, that the entire process is controlled from design to procurement, to and through shipping and delivery, to a pre-assembly and fulfillment center, to location and through assembly. Advantages of the present invention over the prior art in view of FIGS. 11, 12, 14, 15, 19-24, and 26-28 will now be described. Construction, in the conventional sense, is entirely avoided. Conventional construction, beyond mortgage payments, requires costly home repairs, cleaning, and maintenance. The disclosed embodiments provide a fully optimized process that manages and controls the entire process chain including the designing of performance shelters that reduce costly expenditures caused by conventional construction. Newer materials provides realized savings in the way of lower taxes and less money spent on utilities. Through this optimized process, cost savings are realized by eliminating costly services (i.e. subcontractors). Manufacturing may be performed within standard sized configurations to not incur off-size wastes or price markups. Standard size configurations ensure that every component not only fits into standard shipping containers, but of a reasonable weight so that each and every component may be lifted by 1 or 2 people. Reasonable weights for each component eliminates the need for heavy machinery, such as forklifts. Even further, standard size components enable the interconnecting of components by non-skilled persons.

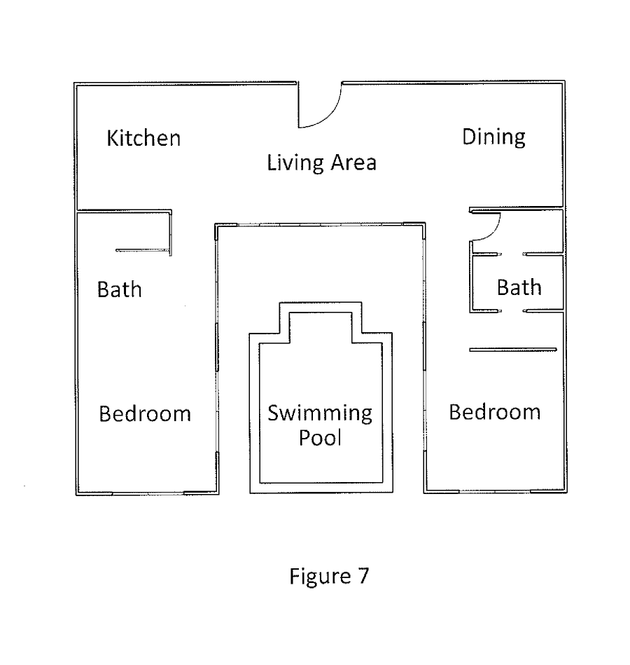

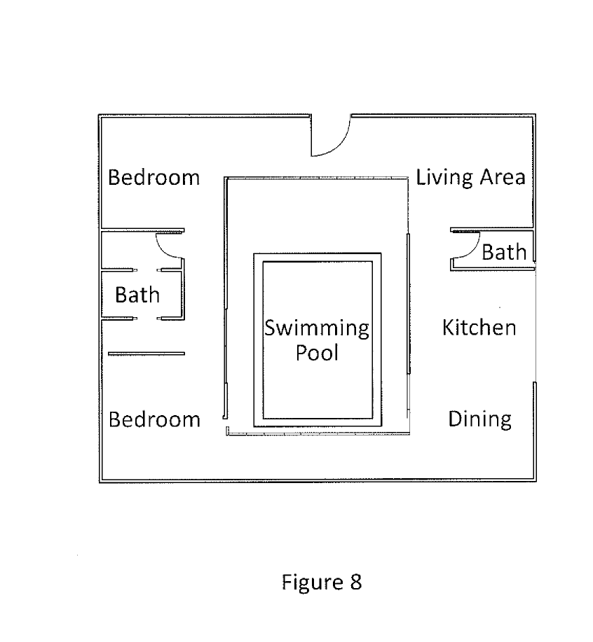

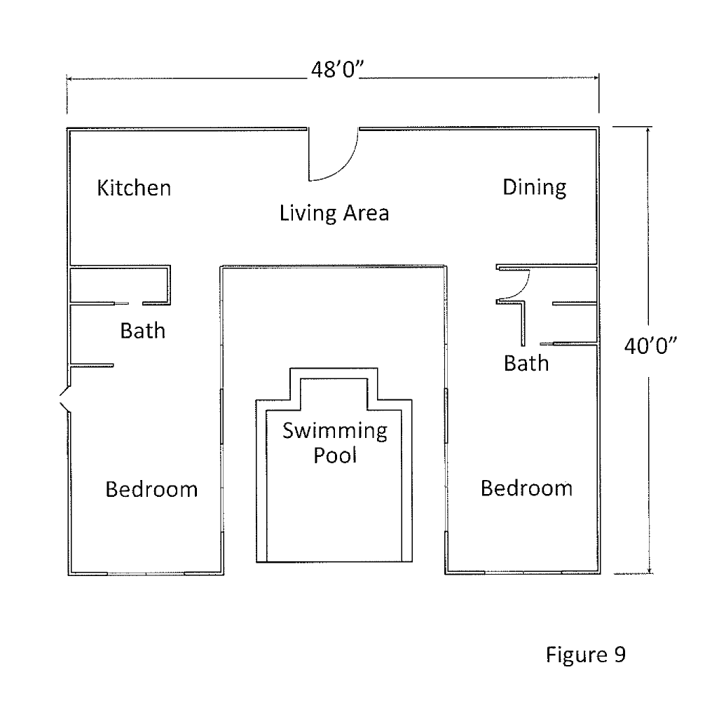

As discussed above, and as illustrated in FIGS. 7-9, the present invention may offer to a user a predesigned template to follow. These templates may be altered and or modified and/or provided as-is. One of these examples may be already produced and packed and ready for shipment, allowing for “real-time” purchasing of the product of the present invention which may allow for a dwelling to be assembled days after being ordered. The present invention may allow for the total constructed costs of a dwelling to be in the range of about $200 to about $100 per square foot. In an embodiment of the present invention, the cost per square foot is less than about $80.

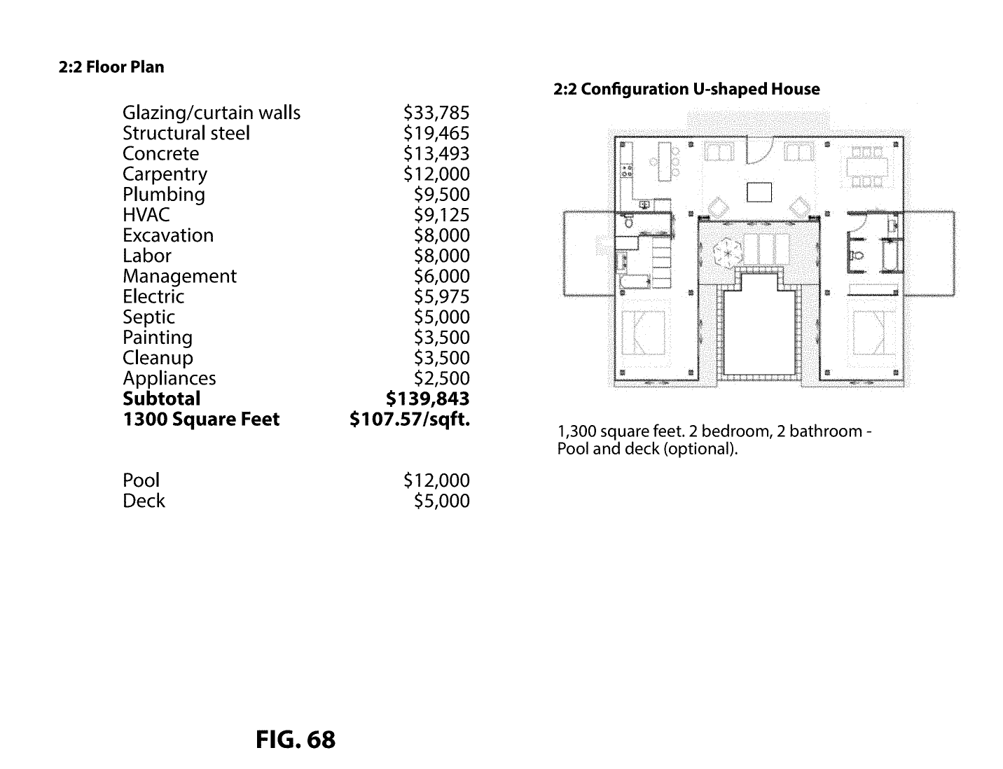

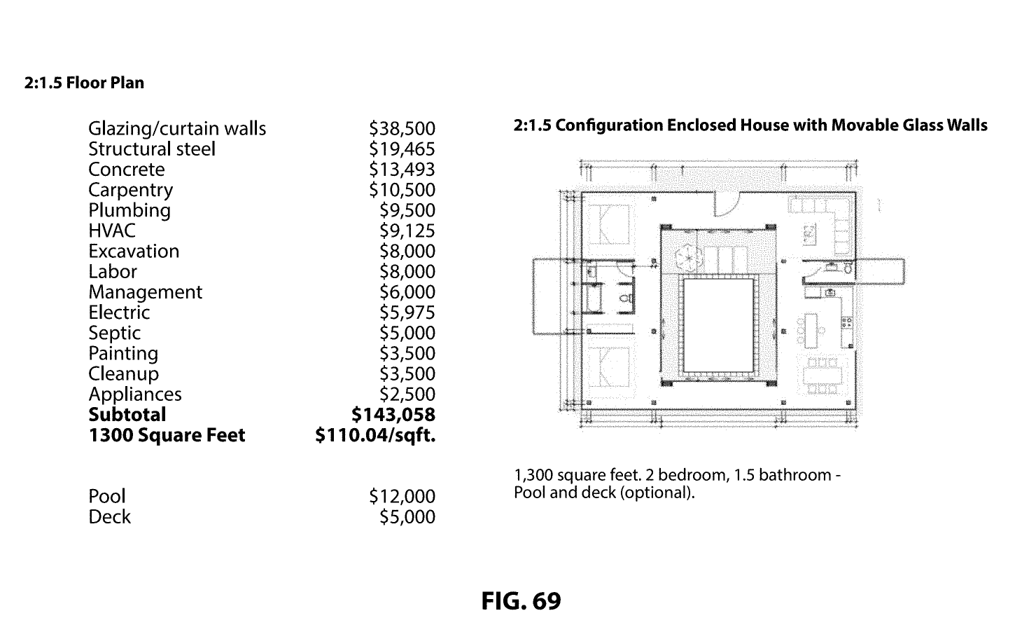

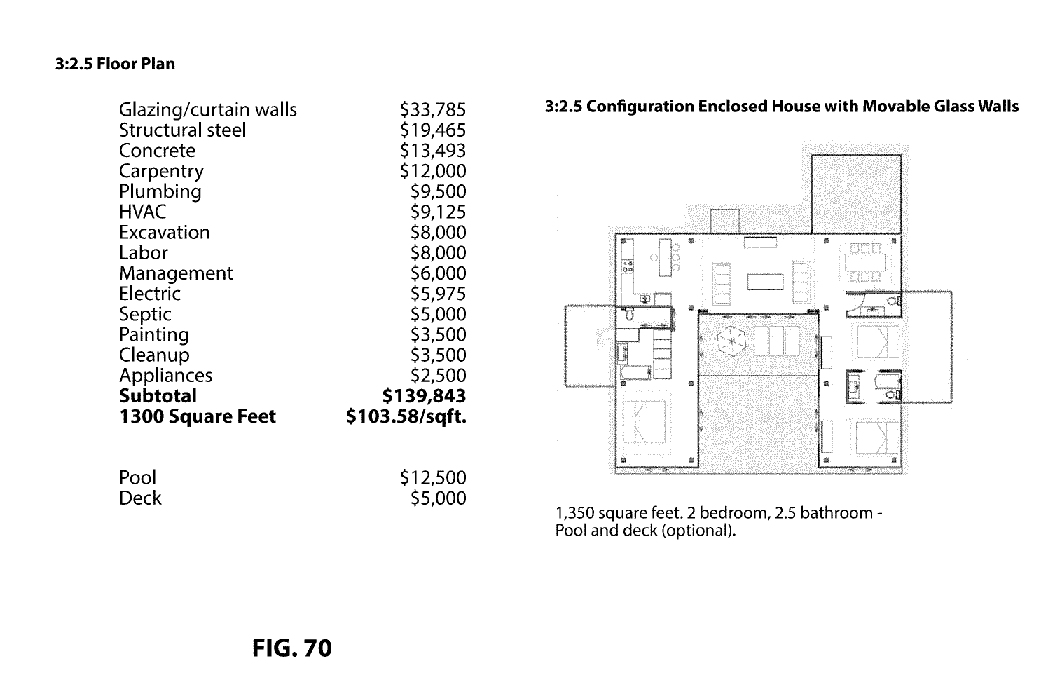

FIGS. 68-70 provide at least three exemplary floor plans that may be generated using the applications set forth herein and above. The exemplary floor plans provided are not intended to be limiting. In each example, cost estimates may be provided to assist with overall planning for a dwelling. The floor plans may include, but are not limited to, glazing/curtain walls, structural steel, concrete, carpentry, plumbing, HVAC systems, excavation, labor costs, management costs, electric installation, septic, painting, cleanup, and appliances. Cost estimation may further include blueprint diagrams and price per square foot cost estimation. Add-on items may be included further to provide a user with the option to add-on later, such as an outside entertainment area, landscaping, hardscaping, a pool, and/or a deck.

Those of skill in the art will appreciate that the herein described systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A system for providing customized structures at a remote location, over a network, responsively to input structure information comprising at least one certified information input, comprising:
a graphical user interface capable of locally querying a structure requester for the input structure information comprising at least general structure information, structure attribute information, land information, and the at least one certified information input;
at least one network port capable of remotely receiving the structure 1information from said graphical user interface; and
at least one rules engine communicatively connected to said at least one network port, and comprising a plurality of rules to generate, responsively to the input structure information, at least one the verified order for a customized structure.

2. A method for purchasing a dwelling through at least one interface, the method comprising, with at least one computing device:
authorizing at least one user through the at least one interface;
receiving one or more parameters through the at least one interface from the user;
virtually building the dwelling based on one or more standards, preferences, and price point;
manufacturing one or more pieces based on the virtual build; and
shipping for assembly the one or more pieces to a remote location.

3. The method of claim 2, wherein authorizing further comprises:
establishing credit worthiness of the user; and
establishing that the user is in possession of sufficient funds for at least a predetermined certain minimum.

4. The method of claim 2, wherein the one or more parameters comprise:
building site attributes, user preferences and expenditure ranges.

5. The method of claim 2, wherein the one or more pieces are labeled using color, numbers, barcodes, and/or NFC tags.

6. A system for purchasing a dwelling through at least one interface, the system comprising at least one memory comprising instructions that when executed by a hardware processor are configured to implement the method of:
authorizing at least one user through the at least one interface;
receiving one or more parameters through the at least one interface from the user;
virtually building the dwelling based on one or more standards, preferences, and price point;
manufacturing one or more pieces based on the virtual build; and
shipping for assembly the one or more pieces to a remote location.

7. The system of claim 6, wherein authorizing further comprises:
establishing credit worthiness of the user; and
establishing that the user is in possession of sufficient funds for at least a predetermined certain minimum.

8. The system of claim 6, wherein the one or more parameters comprise:
building site attributes, user preferences and expenditure ranges.

9. The system of claim 6, wherein the one or more pieces are labeled using color, numbers, barcodes, and/or NFC tags.
